(19) United States
(12) Patent Application Publication
(10) Pub. No.: US 2025/0190878 A1
(43) Pub. Date: Jun. 12, 2025

(54) CROSS-DOMAIN RECOMMENDATION MODEL TRAINING METHOD AND APPARATUS, DEVICE, AND MEDIUM

(71) Applicant: TENCENT TECHNOLOGY (SHENZHEN) COMPANY LIMITED, Shenzhen (CN)

(72) Inventors: Qi YE, Shenzhen (CN); Feng WANG, Shenzhen (CN); Zhiyong ZHENG, Shenzhen (CN)

(21) Appl. No.: 19/055,454

(22) Filed: Feb. 17, 2025

Related U.S. Application Data
(63) Continuation of application No. PCT/CN2023/128554, filed on Oct. 31, 2023.

(30) Foreign Application Priority Data
Jan. 13, 2023 (CN) 202310084391.9

(51) Int. Cl. G06N 20/00

(52) U.S. Cl. CPC G06N 20/00

(57) ABSTRACT

A cross-domain recommendation model training method includes: constructing a heterogeneous network, the heterogeneous network including a node bipartite graph between sample source-domain content nodes and sample target-domain content nodes, a first label bipartite graph between the sample source-domain content nodes and sample source-domain semantic labels, and a second label bipartite graph between the sample target-domain content node and sample target-domain semantic labels; generating a training sample based on a sample source-domain content node and a sample target-domain content node between which a connecting edge exists in the node bipartite graph, a sample source-domain semantic label corresponding to the sample source-domain content node in the first label bipartite graph, and a sample target-domain semantic label corresponding to the sample target-domain content node in the second label bipartite graph; and training a cross-domain recommendation model based on the training sample.

### CROSS-REFERENCES TO RELATED APPLICATIONS

This application is a continuation application of PCT Patent Application No. PCT/CN2023/128554, filed on Oct. 31, 2023, which claims priority to Chinese Patent Application No. 202310084391.9, entitled “CROSS-DOMAIN RECOMMENDATION MODEL TRAINING METHOD AND APPARATUS, DEVICE, MEDIUM, AND PRODUCT” filed on Jan. 13, 2023, both of which are incorporated herein by reference in their entirety.

### FIELD OF THE TECHNOLOGY

The present disclosure relates to the field of artificial intelligence (AI), and in particular, to a cross-domain recommendation model training method and apparatus, a device, a medium, and a product.

### BACKGROUND OF THE DISCLOSURE

With rapid development of Internet technologies, users may choose their preferred contents to browse on the Internet, and servers may recommend similar contents to the users according to daily preferences of the users.

Target contents are usually directly recommended to users, to recall target contents with high similarities to preferred contents of the users, and recommend the target contents to the users. Alternatively, target contents are recommended according to content features of preferred contents of users, to recall target contents with content features highly similar to those of the preferred contents of the users, and recommend the target contents to the users. However, user nodes need to be introduced to the foregoing recommendation methods. Therefore, the recommendation methods are affected by a scale of users to some extent. When the scale of users is small, a recommendation model can use a small amount of data. This may lead to a problem of insufficient correlation between a recommended target content and a preferred content of a user.

### SUMMARY

The present disclosure provides a cross-domain recommendation model training method and apparatus, a device, a medium, and a product. The technical solutions are as follows:

According to an aspect of the present disclosure, a cross-domain recommendation model training method is provided. The method includes: constructing a heterogeneous network, the heterogeneous network including a node bipartite graph between sample source-domain content nodes and sample target-domain content nodes, a first label bipartite graph between the sample source-domain content nodes and sample source-domain semantic labels, and a second label bipartite graph between the sample target-domain content node and sample target-domain semantic labels; generating a training sample based on a sample source-domain content node and a sample target-domain content node between which a connecting edge exists in the node bipartite graph, a sample source-domain semantic label corresponding to the sample source-domain content node in the first label bipartite graph, and a sample target-domain semantic label corresponding to the sample target-domain content node in the second label bipartite graph; and training a cross-domain recommendation model based on the training sample.

According to another aspect of the present disclosure, a cross-domain recommendation method is provided. The method includes: obtaining a historical behavior of a user account; determining, based on the historical behavior of the user account, a source-domain content that historically interacted with the user account; determining, based on a similarity between a source-domain content vector and a target-domain content vector, a target-domain content corresponding to the source-domain content; and recommending the target-domain content to the user account, the source-domain content vector being a feature vector of the source-domain content, the target-domain content vector being a feature vector of the target-domain content, the source-domain content vector being constructed based on the source-domain content and a source-domain semantic label corresponding to the source-domain content in a first label bipartite graph, the target-domain content vector being constructed based on the target-domain content and a target-domain semantic label corresponding to the target-domain content in a second label bipartite graph, the first label bipartite graph being constructed based on source-domain contents and source-domain semantic labels, and the second label bipartite graph being constructed based on target-domain contents and target-domain semantic labels.

According to another aspect of the present disclosure, a cross-domain recommendation model training apparatus is provided. The apparatus includes: a construction module, configured to construct a heterogeneous network, the heterogeneous network including a node bipartite graph between sample source-domain content nodes and sample target-domain content nodes, a first label bipartite graph between the sample source-domain content nodes and sample source-domain semantic labels, and a second label bipartite graph between the sample target-domain content node and sample target-domain semantic labels; a generation module, configured to generate a training sample based on a sample source-domain content node and a sample target-domain content node between which a connecting edge exists in the node bipartite graph, a sample source-domain semantic label corresponding to the sample source-domain content node in the first label bipartite graph, and a sample target-domain semantic label corresponding to the sample target-domain content node in the second label bipartite graph; and a training module, configured to train a cross-domain recommendation model based on the training sample.

According to another aspect of the present disclosure, a cross-domain recommendation apparatus is provided. The apparatus includes: an obtaining module, configured to obtain a historical behavior of a user account; a determining module, configured to determine, based on the historical behavior of the user account, a source-domain content that historically interacted with the user account, the determining module being further configured to determine, based on a similarity between a source-domain content vector and a target-domain content vector, a target-domain content corresponding to the source-domain content; and a recommendation module, configured to recommend the target-domain content to the user account, the source-domain content vector being a feature vector of the source-domain content, the target-domain content vector being a feature vector of the target-domain content, the source-domain content vector being constructed based on the source-domain content and a source-domain semantic label corresponding to the source-domain content in a first label bipartite graph, the target-domain content vector being constructed based on the target-domain content and a target-domain semantic label corresponding to the target-domain content in a second label bipartite graph, the first label bipartite graph being constructed based on source-domain contents and source-domain semantic labels, and the second label bipartite graph being constructed based on target-domain contents and target-domain semantic labels.

According to another aspect of the present disclosure, a computer device is provided. The computer device includes: a processor and a memory, the memory having at least one program stored therein, and the at least one program being loaded and executed by the processor to implement the cross-domain recommendation model training method and the cross-domain recommendation method described in the foregoing aspects.

According to another aspect of the present disclosure, a non-transitory computer-readable storage medium is provided, the computer-readable storage medium having at least one program stored therein, and the at least one program being loaded and executed by a processor to implement the cross-domain recommendation model training method and the cross-domain recommendation method described in the foregoing aspects.

The technical solutions provided in the present disclosure have at least the following beneficial effects: A source-domain content node and a target-domain content node are associated by constructing the heterogeneous network that includes the node bipartite graph between the sample source-domain content nodes and the sample target-domain content nodes, the label bipartite graph between the sample source-domain content node and the sample source-domain semantic label, and the label bipartite graph between the sample target-domain content node and the sample target-domain semantic label. In addition, feature representations of the source-domain content node and the target-domain content node are enhanced by using a source-domain semantic label and a target-domain semantic label. The cross-domain recommendation model is trained by using the training sample generated based on the sample source-domain content node, the sample target-domain content node, the source-domain semantic label, and the target-domain semantic label, so that the cross-domain recommendation model can fully learn an embedded representation of a target content that is to be recommended. This overcomes impact caused by user data sparsity. Therefore, the cross-domain recommendation model is better used to recommend a target content with high correlation to a user.

### BRIEF DESCRIPTION OF THE DRAWINGS

To describe the technical solutions in the embodiments of the present disclosure more clearly, the following briefly describes the accompanying drawings for describing the embodiments.

FIG. 1 is a structural diagram of a computer system according to an exemplary embodiment of the present disclosure.

FIG. 2 is a flowchart of a cross-domain recommendation model training method according to an exemplary embodiment of the present disclosure.

FIG. 3 is a structural diagram of a cross-domain recommendation model according to an exemplary embodiment of the present disclosure.

FIG. 4 is a flowchart of a cross-domain recommendation model training method according to an exemplary embodiment of the present disclosure.

FIG. 5 is a structural diagram of a cross-domain recommendation model according to an exemplary embodiment of the present disclosure.

FIG. 6 is a flowchart of a cross-domain recommendation model training method according to an exemplary embodiment of the present disclosure.

FIG. 7 is a structural diagram of a cross-domain recommendation model according to an exemplary embodiment of the present disclosure.

FIG. 8 is a structural diagram of a cross-domain recommendation model according to an exemplary embodiment of the present disclosure.

FIG. 9 is a structural diagram of a cross-domain recommendation model according to an exemplary embodiment of the present disclosure.

FIG. 10 is a structural diagram of a cross-domain recommendation model according to an exemplary embodiment of the present disclosure.

FIG. 11 is a flowchart of a cross-domain recommendation model training method according to an exemplary embodiment of the present disclosure.

FIG. 12 is a structural diagram of a cross-domain recommendation model according to an exemplary embodiment of the present disclosure.

FIG. 13 is a structural diagram of a cross-domain recommendation model according to an exemplary embodiment of the present disclosure.

FIG. 14 is a structural diagram of a cross-domain recommendation model according to an exemplary embodiment of the present disclosure.

FIG. 15 is a structural diagram of a heterogeneous network according to an exemplary embodiment of the present disclosure.

FIG. 16 is a flowchart of a cross-domain recommendation method according to an exemplary embodiment of the present disclosure.

FIG. 17 is a flowchart of a cross-domain recommendation method according to an exemplary embodiment of the present disclosure.

FIG. 18 is a flowchart of a cross-domain recommendation method according to an exemplary embodiment of the present disclosure.

FIG. 19 is a flowchart of a cross-domain recommendation method according to an exemplary embodiment of the present disclosure.

FIG. 20 is a flowchart of a cross-domain recommendation method according to an exemplary embodiment of the present disclosure.

FIG. 21 is a flowchart of a cross-domain recommendation method according to an exemplary embodiment of the present disclosure.

FIG. 22 is a flowchart of a cross-domain recommendation method according to an exemplary embodiment of the present disclosure.

FIG. 23 is a flowchart of a cross-domain recommendation method according to an exemplary embodiment of the present disclosure.

FIG. 24 is a block diagram of a cross-domain recommendation model training apparatus according to an exemplary embodiment of the present disclosure.

FIG. 25 is a block diagram of a cross-domain recommendation apparatus according to an exemplary embodiment of the present disclosure.

FIG. 26 is a block diagram of a computer device according to an exemplary embodiment of the present disclosure.

### DESCRIPTION OF EMBODIMENTS

To make objectives, technical solutions, and advantages of the present disclosure clearer, the following further describes implementations of the present disclosure in detail with reference to the accompanying drawings.

First, terms in the embodiments of the present disclosure are briefly introduced.

Cross-domain recommendation: is a recommendation method including a source domain and a target domain. A content in the target domain can be recommended from a content in the source domain by using the cross-domain recommendation method.

Semantic label: is a discrete text label related to a content, for example, a label related to a content theme, a label related to one or more keywords in the content, or a label related to a content concept.

Recommendation system: is an information filtering system, and recommends, according to historical behaviors of users such as watching a video, commenting, and browsing a web page, contents that meet preferences of the users, or recommends, according to content features of preferred contents of users such as a title of an article, classification of a video content, and an author of music, contents with similar features.

Co-occurrence network: is a network that is constructed based on at least two nodes and that reflects a co-occurrence of the at least two nodes in a same scenario. When two nodes co-occur in a same scenario, an edge is connected between the two nodes, and a weight on the edge represents a quantity of co-occurrences between the at least two nodes. A greater weight on the edge represents a stronger connection between the two nodes.

Embedded representation: is a distributed representation that is of an input object and that is generated based on a neural network model. A main function is to transform high-dimensional and sparse vectors of original objects into low-dimensional and dense vectors, so that these low-dimensional and dense vectors can express one or more features of the corresponding objects. In addition, a distance between different vectors can reflect a similarity between objects.

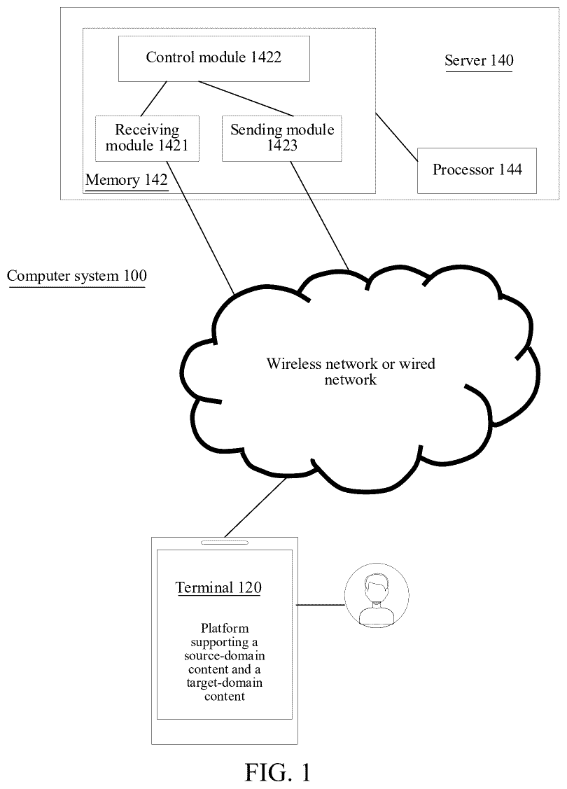

FIG. 1 is a block diagram of a structure of a computer system according to an exemplary embodiment of the present disclosure. The computer system 100 includes a terminal 120 and a server 140.

A platform supporting a source-domain content and a target-domain content is installed and runs on the terminal 120. The source-domain content is a multimedia content that can be browsed, watched, read, or listened to on the terminal 120, for example, a video that can be watched on the terminal 120 through a video playing platform, news that can be read on the terminal 120 through a news platform, or music that can be listened to on the terminal 120 through a music platform. The target-domain content is a multimedia content that can be browsed, watched, read, or listened to on the terminal 120, for example, a video that can be watched on the terminal 120 through a video playing platform, news that can be read on the terminal 120 through a news platform, or music that can be listened to on the terminal 120 through a music platform. A user account has logged in to the platform, and the user account browses and interacts with, through the platform, the source-domain content or the target-domain content displayed on the platform. For example, the user account may click/tap the source-domain content or the target-domain content to watch or read, and may like, comment, share, report, not watch, or perform another operation on a source-domain content or a target-domain content being watched or browsed. Information about the user account is obtained with permission and in compliance with relevant provisions of the law.

The terminal 120 is connected to the server 140 through a wireless network or a wired network.

The server 140 includes at least one of one server, a plurality of servers, a cloud computing platform, and a virtualization center. For example, the server 140 includes a processor 144 and a memory 142. The memory 142 includes at least one module configured to perform different operations. An example in which the memory 142 includes a receiving module 1421, a control module 1422, and a sending module 1423 is used in this embodiment of the present disclosure for description. The receiving module 1421 is configured to receive a request, for example, a request for liking the source-domain content or the target-domain content, from the terminal 120. The control module 1422 is configured to control playback and display of the source-domain content and the target-domain content. The sending module 1423 is configured to send a response to the terminal 120, for example, send a feedback to the terminal 120 on whether the source-domain content and the target-domain content is successfully liked. A person skilled in the art may learn that there may be more or fewer modules in the memory 142. A quantity of modules is not limited in this embodiment of the present disclosure.

In some embodiments, the server 140 is responsible for primary computing work, and the terminal 120 is responsible for secondary computing work; the server 140 is responsible for secondary computing work, and the terminal 120 is responsible for primary computing work; or the server 140 and the terminal 120 are responsible for computing work in a coordinated manner.

In some embodiments, the foregoing platform supporting the source-domain content and the target-domain content is a same platform on different operating system platforms (Android or iOS). In some embodiments, device types of the terminal 120 are the same or different. The device types include: at least one of a smartphone, a smart watch, a vehicle-mounted terminal, a wearable device, a smart television, a tablet computer, an e-book reader, an MP3 player, an MP4 player, a laptop portable computer, and a desktop computer.

A person skilled in the art may learn that there may be more or fewer terminals 120. For example, there may be only one terminal 120, or there may be dozens or hundreds of terminals, or more terminals. In this embodiment of the present disclosure, a quantity of terminals and the device types of the terminals are not limited.

With research and progress of an AI technology, the AI technology is studied in and applied to many fields such as common smart home, self-driving, robots, intelligent medical care, and intelligent customer service. The AI technology is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology in computer science, and attempts to understand the essence of intelligence and produce a new intelligent machine that can react in a manner similar to human intelligence. AI is to study design principles and implementation methods of various intelligent machines, to enable the machines to have functions of perception, reasoning, and decision-making. The AI technology is a comprehensive discipline, and relates to a wide range of fields including both hardware-level technologies and software-level technologies. Basic AI technologies generally include a sensor, a dedicated AI chip, cloud computing, distributed storage, a big data processing technology, an operating/interaction system, electromechanical integration, and the like. AI software technologies mainly include several major directions such as a computer vision technology, a speech processing technology, a natural language processing technology, and machine learning/deep learning.

The solutions provided in the embodiments of the present disclosure relate to a machine learning (ML) technology of AI. Details are described by using the following embodiments;

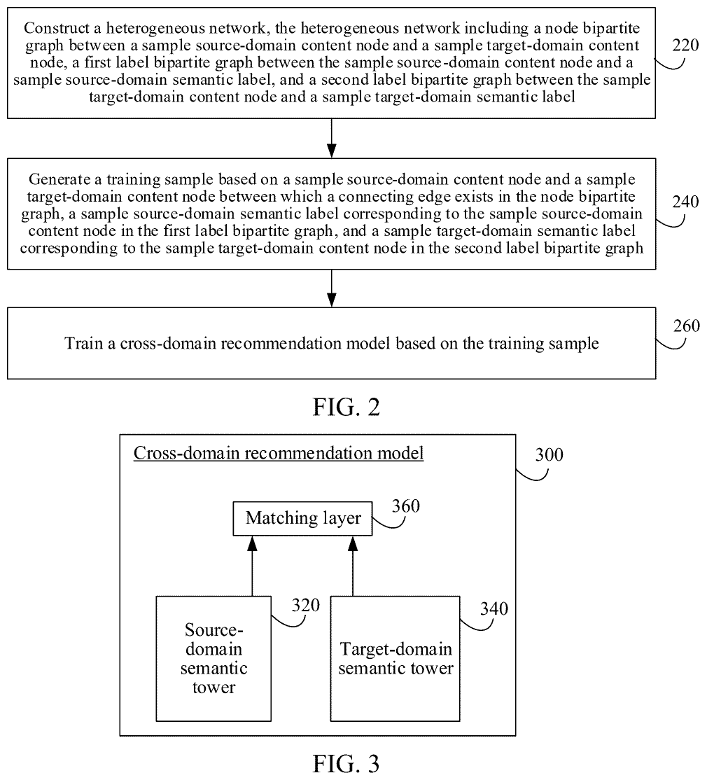

FIG. 2 is a schematic diagram of a cross-domain recommendation model training method according to an exemplary embodiment of the present disclosure. The method is performed by a computer device, and the computer device may be the terminal 120 or the server 140 shown in FIG. 1. The method includes the following operations:

Operation 220: Construct a heterogeneous network, the heterogeneous network including a node bipartite graph between sample source-domain content nodes and sample target-domain content nodes, a first label bipartite graph between the sample source-domain content nodes and sample source-domain semantic labels, and a second label bipartite graph between the sample target-domain content node and sample target-domain semantic labels.

The heterogeneous network including the sample source-domain content node, the sample target-domain content node, the sample source-domain semantic label, and the sample target-domain semantic label is constructed. The sample source-domain content node and the sample target-domain content node are connected through a connecting edge to form the node bipartite graph, the sample source-domain content node and the sample source-domain semantic label are connected through a connecting edge to form the label bipartite graph, and the sample target-domain content node and the sample target-domain semantic label are connected through a connecting edge to form the label bipartite graph.

The sample source-domain content node is obtained according to a sample source-domain content. The sample source-domain content is a multimedia content on which at least one of browsing, watching, reading, and listening operations can be performed on the terminal 120 shown in FIG. 1. For example, the sample source-domain content may be a video, news, or music. The sample target-domain content node is obtained according to a sample target-domain content. The sample target-domain content is a multimedia content on which at least one of browsing, watching, reading, and listening operations can be performed on the terminal 120 shown in FIG. 1. For example, the sample target-domain content may be a video, news, or music. The sample source-domain content and the sample target-domain content are contents operated successively by a user account on the terminal 120 in a period of time. For example, if the user account watches a long video first and then a short video in a period of time, the sample source-domain content is the long video, and the sample target-domain content is the short video.

In some embodiments, the sample source-domain content and the sample target-domain content may be contents in a same domain. For example, both the sample source-domain content and the sample target-domain content are short-video contents, long-video contents, news contents, or commodity contents. In some embodiments, the contents being used for training are in a scale of gigabytes, terabytes, petabytes or more.

In some embodiments, the sample source-domain content and the sample target-domain content may be contents in different domains. For example, the sample source-domain content is a short-video content, and the sample target-domain content is a long-video content; the sample source-domain content is a long-video content, and the sample target-domain content is a short-video content; the sample source-domain content is a video content, and the sample target-domain content is a news content; or the sample source-domain content is a video content, and the sample target-domain content is a commodity content.

Operation 240: Generate a training sample based on a sample source-domain content node and a sample target-domain content node between which a connecting edge exists in the node bipartite graph, a sample source-domain semantic label corresponding to the sample source-domain content node in the first label bipartite graph, and a sample target-domain semantic label corresponding to the sample target-domain content node in the second label bipartite graph.

The training sample is generated based on the sample source-domain content node and the sample target-domain content node between which the connecting edge exists in the node bipartite graph, the sample source-domain semantic label corresponding to the sample source-domain content node in the first label bipartite graph, and the sample target-domain semantic label corresponding to the sample target-domain content node in the second label bipartite graph. The sample source-domain content node and the sample source-domain semantic label corresponding to the sample source-domain content node in the first label bipartite graph are determined as sample source-domain data. The sample target-domain content node and the sample target-domain semantic label corresponding to the sample target-domain content node in the second label bipartite graph are determined as sample target-domain data. The sample source-domain data and the sample target-domain data are determined as the training sample. The training sample includes at least a positive sample that is of the sample target-domain content node and that is recommended from the sample source-domain content node and a negative sample that is of the sample source-domain content node and that is recommended from the sample target-domain content node.

In some embodiments, the sample source-domain content node and the sample target-domain content node may be in one-to-one correspondence. One sample source-domain content node corresponds to one sample target-domain content node.

In some embodiments, the sample source-domain content node and the sample target-domain content node may be in one-to-many correspondence. One sample source-domain content node corresponds to at least two sample target-domain content nodes.

In some embodiments, the sample source-domain content node and the sample target-domain content node may be in many-to-one correspondence. At least two sample source-domain content nodes correspond to one sample target-domain content node.

Operation 260: Train a cross-domain recommendation model based on the training sample.

The training sample is inputted into the cross-domain recommendation model to train the cross-domain recommendation model. The training sample is a set of a plurality of groups of sample data, where any group of sample data includes one sample source-domain content node, one sample target-domain content node, a sample source-domain semantic label corresponding to the sample source-domain content node in the first label bipartite graph, and a sample target-domain semantic label corresponding to the sample target-domain content node in the second label bipartite graph. The sample source-domain content node, the sample target-domain content node, the sample source-domain semantic label corresponding to the sample source-domain content node in the first label bipartite graph, and the sample target-domain semantic label corresponding to the sample target-domain content node in the second label bipartite graph are inputted into the cross-domain recommendation model to train the cross-domain recommendation model. The cross-domain recommendation model is a model for obtaining a target-domain content through cross-domain recommendation from a source-domain content.

In conclusion, according to the method provided in this embodiment, a source-domain content node and a target-domain content node are associated by constructing the heterogeneous network that includes the node bipartite graph between the sample source-domain content nodes and the sample target-domain content nodes, the first label bipartite graph between the sample source-domain content nodes and the sample source-domain semantic labels, and the label bipartite graph between the sample target-domain content node and the sample target-domain semantic label. In addition, feature representations of the source-domain content node and the target-domain content node are enhanced by using a source-domain semantic label and a target-domain semantic label. The cross-domain recommendation model is trained by using the training sample generated based on the sample source-domain content node, the sample target-domain content node, the source-domain semantic label, and the target-domain semantic label, so that the cross-domain recommendation model can fully learn an embedded representation of a target content that is to be recommended. This overcomes impact caused by user data sparsity. Therefore, the cross-domain recommendation model is better used to recommend a target content with high correlation to a user.

In some embodiments, the cross-domain recommendation model includes a source-domain semantic tower, a target-domain semantic tower, and a matching layer. As shown in FIG. 3, a cross-domain recommendation model 300 includes a source-domain semantic tower 320, a target-domain semantic tower 340, and a matching layer 360. An output end of the source-domain semantic tower 320 is connected to an input end of the matching layer 360, and an output end of the target-domain semantic tower 340 is connected to the input end of the matching layer 360.

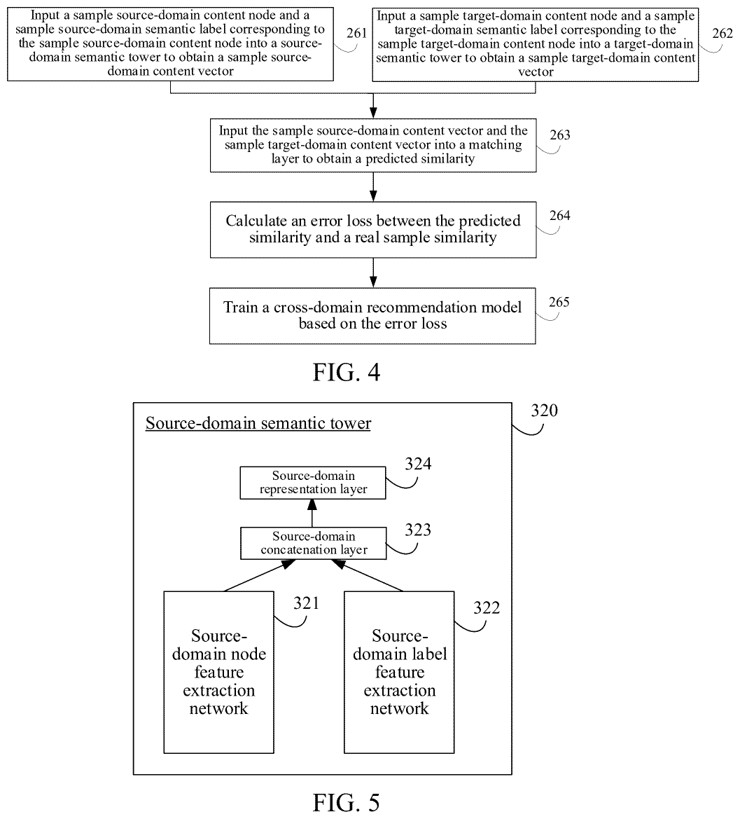

FIG. 4 is a schematic diagram of a cross-domain recommendation model training method according to an exemplary embodiment of the present disclosure. Operation 260 further includes at least one of the following operations:

Operation 261: Input the sample source-domain content node and the sample source-domain semantic label corresponding to the sample source-domain content node into the source-domain semantic tower to obtain a sample source-domain content vector.

The source-domain semantic tower in the cross-domain recommendation model is a network model for generating an embedded representation of the source-domain content. An embedded representation corresponding to the sample source-domain content, namely, the sample source-domain content vector, can be obtained by inputting the sample source-domain content node and the sample source-domain semantic label corresponding to the sample source-domain content node into the source-domain semantic tower. The sample source-domain content node is a node that includes a content feature of the sample source-domain content. For example, the sample source-domain content is a long video, and a content feature of the long video includes a video attribute. The sample source-domain semantic label corresponding to the sample source-domain content node is at least one of labels corresponding to the content feature of the sample source-domain content. For example, labels corresponding to the video attribute include a title label, a theme label, an author label, and an actor label, and the sample source-domain semantic label may be at least one of the labels.

Operation 262: Input the sample target-domain content node and the sample target-domain semantic label corresponding to the sample target-domain content node into the target-domain semantic tower to obtain a sample target-domain content vector.

The target-domain semantic tower in the cross-domain recommendation model is a network model for generating an embedded representation of the target-domain content. An embedded representation corresponding to the sample target-domain content, namely, the sample target-domain content vector, can be obtained by inputting the sample target-domain content node and the sample target-domain semantic label corresponding to the sample target-domain content node into the target-domain semantic tower. The sample target-domain content node is a node that includes a content feature of the sample target-domain content. For example, the sample target-domain content is a long video, and a content feature of the long video includes a video attribute. The sample target-domain semantic label corresponding to the sample target-domain content node is at least one of labels corresponding to the content feature of the sample target-domain content. For example, labels corresponding to the video attribute include a title label, a theme label, an author label, and an actor label, and the sample target-domain semantic label may be at least one of the labels.

Operation 263: Input the sample source-domain content vector and the sample target-domain content vector into the matching layer to obtain a predicted similarity.

The matching layer in the cross-domain recommendation model is configured for calculating correlation between a source-domain content vector outputted by the source-domain semantic tower and a target-domain content vector outputted by the target-domain semantic tower. The sample source-domain content vector obtained through the source-domain semantic tower and the sample target-domain content vector obtained through the target-domain semantic tower are inputted into the matching layer, a cosine similarity between the two vectors is calculated by using a cosine function, and the cosine similarity is used as the predicted similarity between the sample source-domain content and the sample target-domain content.

Operation 264: Calculate an error loss between the predicted similarity and a real sample similarity.

The positive sample (from the source-domain content to the target-domain content) in the training sample is marked as 1, and the negative sample (from the target-domain content to the source-domain content) is marked as 0. In this case, a binary-classification training sample is obtained. A sum of probabilities of the binary-classification training sample is 1, to be specific, for a same source-domain content and target-domain content, the user can only operate the source-domain content before the target-domain content or operate the target-domain content before the source-domain content.

The error loss between the predicted similarity and the real sample similarity is calculated by using binary cross entropy as a loss function. A formula of the loss function is:

$$Loss = - ( y \cdot log ( \hat{y} ) + ( 1 - y ) \cdot log ( 1 - \hat{y} ) )$$

Loss represents the error loss, y represents the real sample similarity, and ŷ represents the predicted similarity.

Operation 265: Train the cross-domain recommendation model based on the error loss.

The real sample similarity between the sample source-domain data and the sample target-domain data is determined based on a weight on the connecting edge between the sample source-domain content node and the sample target-domain content node, where the weight is determined based on a quantity of co-occurrences between the sample source-domain content node and the sample target-domain content node in a period of time. The error loss between the predicted similarity obtained through the cross-domain recommendation model and the real sample similarity is determined by using the binary cross entropy loss function, and the error is fed back to the cross-domain recommendation model to train the cross-domain recommendation model.

In conclusion, according to the method provided in this embodiment, the sample source-domain content node and the sample source-domain semantic label corresponding to the sample source-domain content node are inputted into the source-domain semantic tower, and the sample target-domain content node and the sample target-domain semantic label corresponding to the sample target-domain content node are inputted into the target-domain semantic tower, to obtain the corresponding content vectors, so that a richer and more detailed content representation can be obtained. The corresponding content vectors are inputted into the matching layer for matching to obtain the predicted similarity of the two content vectors, so that a degree of similarity between the two content vectors can be better measured. The error loss between the predicted similarity and the real sample similarity is calculated by using the loss function to train the cross-domain recommendation model, so that the predicted similarity calculated by using the cross-domain recommendation model is infinitely close to the real sample similarity. This can improve accuracy and robustness of a recommendation system.

In some embodiments, the source-domain semantic tower includes a source-domain node feature extraction network, a source-domain label feature extraction network, a source-domain concatenation layer, and a source-domain representation layer that are cascaded. As shown in FIG. 5, the source-domain semantic tower 320 includes a source-domain node feature extraction network 321, a source-domain label feature extraction network 322, a source-domain concatenation layer 323, and a source-domain representation layer 324 that are cascaded. An input end of the source-domain node feature extraction network 321 is connected to the source-domain content node, an output end of the source-domain node feature extraction network 321 is connected to the source-domain concatenation layer 323, an output end of the source-domain label feature extraction network 322 is connected to an input end of the source-domain concatenation layer 323, and an output end of the source-domain concatenation layer 323 is connected to an input end of the source-domain representation layer 324.

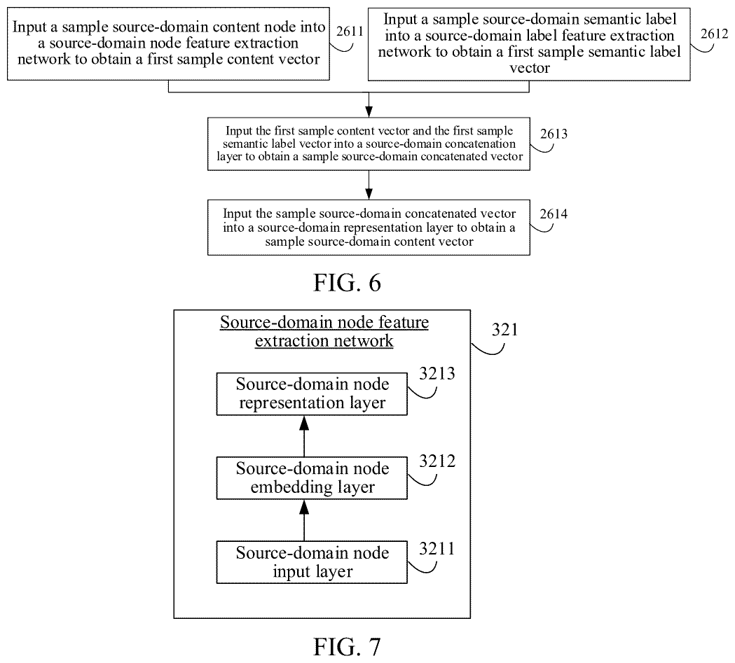

FIG. 6 is a schematic diagram of a cross-domain recommendation model training method according to an exemplary embodiment of the present disclosure. Operation 261 further includes at least one of the following operations:

Operation 2611: Input the sample source-domain content node into the source-domain node feature extraction network to obtain a first sample content vector.

In some embodiments, the source-domain node feature extraction network includes a source-domain node input layer, a source-domain node embedding layer, and a source-domain node representation layer that are cascaded. As shown in FIG. 7, the source-domain node feature extraction network 321 includes a source-domain node input layer 3211, a source-domain node embedding layer 3212, and a source-domain node representation layer 3213 that are cascaded. An input end of the source-domain node input layer 3211 is connected to the source-domain content node, an output end of the source-domain node input layer 3211 is connected to an input end of the source-domain node embedding layer 3212, an output end of the source-domain node embedding layer 3212 is connected to an input end of the source-domain node representation layer 3213, and an output end of the source-domain node representation layer 3213 is connected to the input end of the source-domain concatenation layer 323.

A first sample content feature of the sample source-domain content node is inputted through the source-domain node input layer. The first sample content feature at the source-domain node input layer is outputted, and embedding representation is performed on the first sample content feature through the source-domain node embedding layer, to obtain an embedded representation vector of a first sample content. The embedded representation vector of the first sample content at the source-domain node embedding layer is outputted, and the embedded representation vector of the first sample content is learned through the source-domain node representation layer to obtain the first sample content vector.

Operation 2612: Input the sample source-domain semantic label into the source-domain label feature extraction network to obtain a first sample semantic label vector.

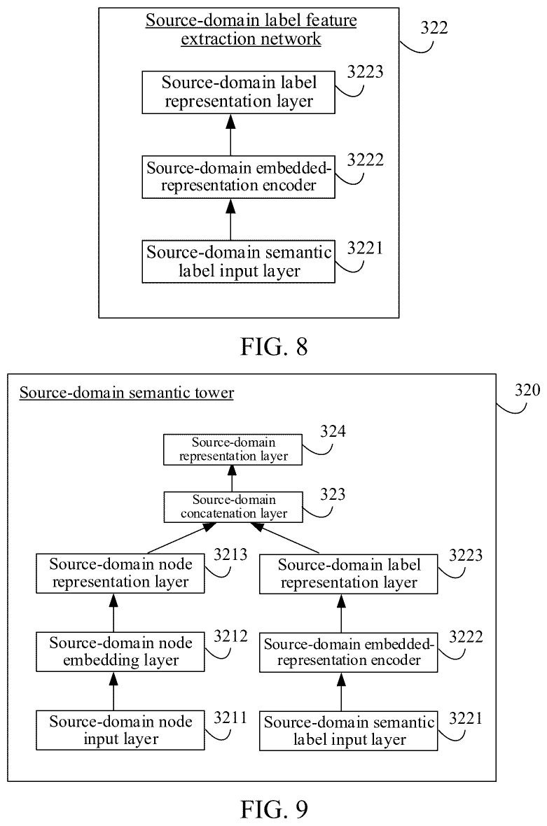

In some embodiments, the source-domain label feature extraction network includes a source-domain semantic label input layer, a source-domain embedded-representation encoder, and a source-domain label representation layer that are cascaded. As shown in FIG. 8, the source-domain label feature extraction network 322 includes a source-domain semantic label input layer 3221, a source-domain embedded-representation encoder 3222, and a source-domain label representation layer 3223 that are cascaded. An input end of the source-domain semantic label input layer 3221 is connected to the source-domain semantic label, an output end of the source-domain semantic label input layer 3221 is connected to an input end of the source-domain embedded-representation encoder 3222, an output end of the source-domain embedded-representation encoder 3222 is connected to an input end of the source-domain label representation layer 3223, and an output end of the source-domain label representation layer 3223 is connected to the input end of the source-domain concatenation layer 323.

A first sample semantic feature of the sample source-domain semantic label is inputted through the source-domain semantic label input layer. The first sample semantic feature at the source-domain semantic label input layer is outputted, and embedding representation is performed on the first sample semantic feature through the source-domain embedded-representation encoder to obtain an embedded representation vector of a first sample semantic label. The embedded representation vector of the first sample semantic label in the source-domain embedded-representation encoder is outputted, and the embedded representation vector of the first sample semantic label is learned through the source-domain label representation layer to obtain the first sample semantic label vector.

Operation 2613: Input the first sample content vector and the first sample semantic label vector into the source-domain concatenation layer to obtain a sample source-domain concatenated vector.

As shown in FIG. 9, the source-domain semantic tower 320 outputs the first sample content vector through the source-domain node input layer 3211, the source-domain node embedding layer 3212, and the source-domain node representation layer 3213 that are cascaded, and outputs the first sample semantic label vector through the source-domain node input layer 3211, the source-domain node embedding layer 3212, and the source-domain node representation layer 3213 that are cascaded.

The first sample content vector and the first sample semantic label vector are inputted into the source-domain concatenation layer 323, to perform vector concatenation on the first sample content vector and the first semantic label vector to obtain the sample source-domain concatenated vector.

Operation 2614: Input the sample source-domain concatenated vector into the source-domain representation layer to obtain the sample source-domain content vector.

As shown in FIG. 9, the sample source-domain concatenated vector outputted by the source-domain concatenation layer 323 is inputted into the source-domain representation layer 324 to obtain the sample source-domain content vector. The sample source-domain content vector includes a complete feature vector of the sample source-domain content, where the complete feature vector is obtained based on the sample source-domain content node and the sample source-domain semantic label corresponding to the sample source-domain content node.

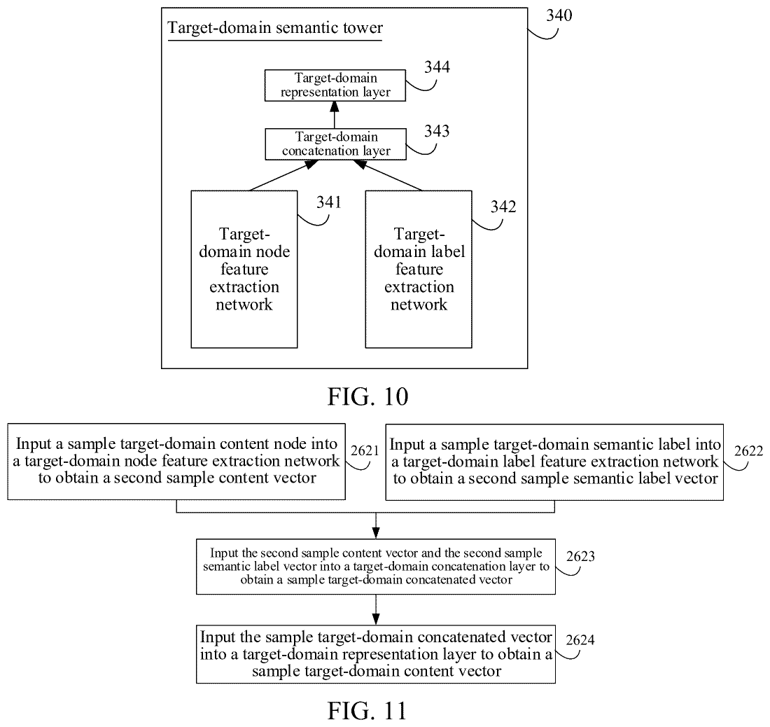

In some embodiments, the target-domain semantic tower includes a target-domain node feature extraction network, a target-domain label feature extraction network, a target-domain concatenation layer, and a target-domain representation layer that are cascaded. As shown in FIG. 10, the target-domain semantic tower 340 includes a target-domain node feature extraction network 341, a target-domain label feature extraction network 342, a target-domain concatenation layer 343, and a target-domain representation layer 344 that are cascaded. An input end of the target-domain node feature extraction network 341 is connected to the target-domain content node, an output end of the target-domain node feature extraction network 341 is connected to the target-domain concatenation layer 343, an output end of the target-domain label feature extraction network 342 is connected to an input end of the target-domain concatenation layer 343, and an output end of the target-domain concatenation layer 343 is connected to an input end of the target-domain representation layer 344.

FIG. 11 is a schematic diagram of a cross-domain recommendation model training method according to an exemplary embodiment of the present disclosure. Operation 262 further includes at least one of the following operations:

Operation 2621: Input the sample target-domain content node into the target-domain node feature extraction network to obtain a second sample content vector.

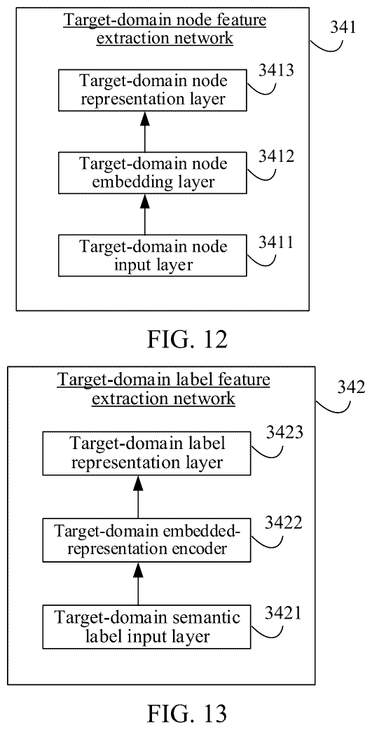

In some embodiments, the target-domain node feature extraction network includes a target-domain node input layer, a target-domain node embedding layer, and a target-domain node representation layer that are cascaded. As shown in FIG. 12, the target-domain node feature extraction network 341 includes a target-domain node input layer 3411, a target-domain node embedding layer 3412, and a target-domain node representation layer 3413 that are cascaded. An input end of the target-domain node input layer 3411 is connected to the target-domain content node, an output end of the target-domain node input layer 3411 is connected to an input end of the target-domain node embedding layer 3412, an output end of the target-domain node embedding layer 3412 is connected to an input end of the target-domain node representation layer 3413, and an output end of the target-domain node representation layer 3413 is connected to the input end of the target-domain concatenation layer 343.

A second sample content feature of the sample target-domain content node is inputted through the target-domain node input layer. The second sample content feature at the target-domain node input layer is outputted, and embedding representation is performed on the second sample content feature through the target-domain node embedding layer, to obtain an embedded representation vector of a second sample content. The embedded representation vector of the second sample content at the target-domain node embedding layer is outputted, and the embedded representation vector of the second sample content is learned through the target-domain node representation layer to obtain the second sample content vector.

Operation 2622: Input the sample target-domain semantic label into the target-domain label feature extraction network to obtain a second sample semantic label vector.

In some embodiments, the target-domain label feature extraction network includes a target-domain semantic label input layer, a target-domain embedded-representation encoder, and a target-domain label representation layer that are cascaded. As shown in FIG. 13, the target-domain label feature extraction network 342 includes a target-domain semantic label input layer 3421, a target-domain embedded-representation encoder 3422, and a target-domain label representation layer 3423 that are cascaded. An input end of the target-domain semantic label input layer 3421 is connected to a target-domain semantic label, an output end of the target-domain semantic label input layer 3421 is connected to an input end of the target-domain embedded-representation encoder 3422, an output end of the target-domain embedded-representation encoder 3422 is connected to an input end of the target-domain label representation layer 3423, and an output end of the target-domain label representation layer 3423 is connected to the input end of the target-domain concatenation layer 343.

A second sample semantic feature of the sample target-domain semantic label is inputted through the target-domain semantic label input layer. The second sample semantic feature at the target-domain semantic label input layer is outputted, and embedding representation is performed on the second sample semantic feature through the target-domain embedded-representation encoder to obtain an embedded representation vector of a second sample semantic label. The embedded representation vector of the second sample semantic label in the target-domain embedded-representation encoder is outputted, and the embedded representation vector of the second sample semantic label is learned through the target-domain label representation layer to obtain the second sample semantic label vector.

Operation 2623: Input the second sample content vector and the second sample semantic label vector into the target-domain concatenation layer to obtain a sample target-domain concatenated vector.

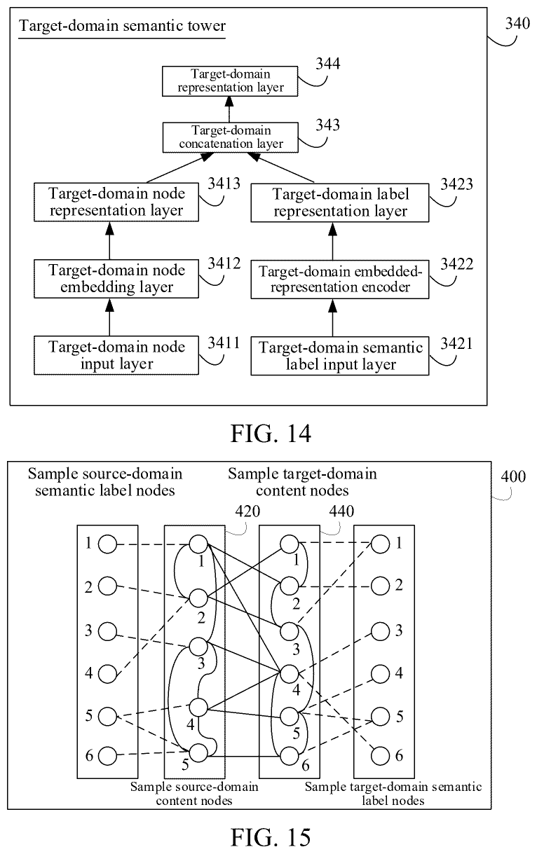

As shown in FIG. 14, the target-domain semantic tower 340 outputs the second sample content vector through the target-domain node input layer 3411, the target-domain node embedding layer 3412, and the target-domain node representation layer 3413 that are cascaded, and outputs the second sample semantic label vector through the target-domain node input layer 3411, the target-domain node embedding layer 3412, and the target-domain node representation layer 3413 that are cascaded.

The second sample content vector and the second sample semantic label vector are inputted into the target-domain concatenation layer 343, to perform vector concatenation on the second sample content vector and the second semantic label vector to obtain the sample target-domain concatenated vector.

Operation 2624: Input the sample target-domain concatenated vector into the target-domain representation layer to obtain the sample target-domain content vector.

As shown in FIG. 14, the sample target-domain concatenated vector outputted by the target-domain concatenation layer 343 is inputted into the target-domain representation layer 344 to obtain the sample target-domain content vector. The sample target-domain content vector includes a complete feature vector of the sample target-domain content, where the complete feature vector is obtained based on the sample target-domain content node and the sample target-domain semantic label corresponding to the sample target-domain content node.

In conclusion, according to the method provided in this embodiment, through the source-domain semantic tower and the target-domain semantic tower, the first sample content vector and the corresponding first sample semantic label vector are concatenated to obtain the sample source-domain content vector including a complete feature of the sample source-domain content, and the second sample content vector and the corresponding second sample semantic label vector are concatenated to obtain the sample target-domain content vector including a complete feature of the sample target-domain content. The content nodes and the corresponding semantic labels are respectively inputted into the source-domain semantic tower and the target-domain semantic tower, so that a more comprehensive and accurate content representation and semantic label representation can be obtained. The content vector and the semantic label vector are concatenated through the concatenation layer to obtain a more complete feature representation.

FIG. 15 is a structural diagram of a heterogeneous network 400 according to an exemplary embodiment of the present disclosure.

The heterogeneous network 400 includes a sample source-domain content node, a sample target-domain content node, a sample source-domain semantic label node associated with the sample source-domain content node, and a sample target-domain semantic label node associated with the sample target-domain content node. The sample source-domain content node and the sample target-domain content node are connected through a connecting edge to form a node bipartite graph, the sample source-domain content node and the sample source-domain semantic label are connected through a connecting edge to form a first label bipartite graph, and the sample target-domain content node and the sample target-domain semantic label are connected through a connecting edge to form a second label bipartite graph.

In some embodiments, the heterogeneous network 400 further includes a source-domain co-occurrence network 420 constructed based on sample source-domain content nodes with a co-occurrence relationship and a target-domain co-occurrence network 440 constructed based on sample target-domain content nodes with a co-occurrence relationship.

### Source-Domain Co-Occurrence Network 420:

The source-domain co-occurrence network is constructed based on historical behaviors of a plurality of user accounts in a source domain. Sample source-domain contents that historically interacted with the plurality of user accounts are determined based on the historical behaviors of the plurality of user accounts in the source domain. For example, it is determined, based on a historical behavior of clicking/tapping a short video by the user account to watch, that the sample source-domain content that historically interacted with the user account is the watched short video. Based on a quantity of co-occurrences between the sample source-domain contents in the same user account in a second period of time, when the quantity of co-occurrences between the sample source-domain contents is greater than a threshold, sample source-domain content nodes corresponding to the sample source-domain contents are connected through a connecting edge to obtain the source-domain co-occurrence network. The period of time may be preset by a system or randomly adjusted according to a specific condition, and may be, for example, one minute, five minutes, or 10 minutes. The threshold may be preset by the system or randomly adjusted according to a specific condition, and may be, for example, three times, five times, or 10 times. Assuming that the period of time is five minutes, the threshold of the quantity of co-occurrences is three times, and the historical behavior of the user account in the source domain is watching a short video, a quantity of co-occurrences between a plurality of short videos is determined based on a behavior of watching the short video by the user account within five minutes, and short videos that co-occur more than three times are connected to obtain the source-domain co-occurrence network.

In some embodiments, sample source-domain content nodes in the source-domain co-occurrence network are in one-to-one correspondence. For example, a sample source-domain content node 2 corresponds to a sample source-domain content node 1.

In some embodiments, sample source-domain content nodes in the source-domain co-occurrence network are in one-to-many correspondence. For example, a sample source-domain content node 4 corresponds to a sample source-domain content node 3 and a sample source-domain content node 5.

### Target-Domain Co-Occurrence Network 440:

The target-domain co-occurrence network is constructed based on historical behaviors of the plurality of user accounts in a target domain. Sample target-domain contents that historically interacted with the plurality of user accounts are determined based on the historical behaviors of the plurality of user accounts in the target domain. For example, it is determined, based on a historical behavior of clicking/tapping a short video by the user account to watch, that the sample target-domain content that historically interacted with the user account is the watched short video. Based on a quantity of co-occurrences between the sample target-domain contents in the same user account in a third period of time, when the quantity of co-occurrences between the sample target-domain contents is greater than a threshold, sample target-domain content nodes corresponding to the sample target-domain contents are connected through a connecting edge to obtain the target-domain co-occurrence network. The period of time may be preset by the system or randomly adjusted according to a specific condition, and may be, for example, one minute, five minutes, or 10 minutes. The threshold may be preset by the system or randomly adjusted according to a specific condition, and may be, for example, three times, five times, or 10 times. Assuming that the period of time is five minutes, the threshold of the quantity of co-occurrences is three times, and the historical behavior of the user account in the target domain is watching a short video, a quantity of co-occurrences between a plurality of short videos is determined based on a behavior of watching the short video by the user account within five minutes, and short videos that co-occur more than three times are connected to obtain the target-domain co-occurrence network.

In some embodiments, sample target-domain content nodes in the target-domain co-occurrence network are in one-to-one correspondence. For example, a sample target-domain content node 1 corresponds to a sample target-domain content node 2.

In some embodiments, sample target-domain content nodes in the target-domain co-occurrence network are in one-to-many correspondence. For example, a sample target-domain content node 5 corresponds to a sample target-domain content node 3 and a sample target-domain content node 6.

### First Label Bipartite Graph Between the Sample Source-Domain Content Nodes and the Sample Source-Domain Semantic Labels:

The first label bipartite graph between the sample source-domain content nodes and the sample source-domain semantic labels is constructed through a semantic label system in the source domain. The semantic label system is configured to perform semantic label modeling on a user or content, to obtain a semantic label corresponding to the user or content. For example, for a short video, a theme label, an author label, a keyword label, a character label, or the like corresponding to the short-video content is obtained through the semantic label system. The sample source-domain semantic label and the sample source-domain content node that are in correspondence are connected through the connecting edge, to obtain the first label bipartite graph between the sample source-domain content nodes and the sample source-domain semantic labels.

In some embodiments, the sample source-domain semantic label node and the sample source-domain content node are in one-to-one correspondence. For example, a sample source-domain semantic label node 1 corresponds to the sample source-domain content node 1, and a sample source-domain semantic label node 3 corresponds to the sample source-domain content node 3.

In some embodiments, the sample source-domain semantic label node and the sample source-domain content node are in one-to-many correspondence. For example, a sample source-domain semantic label node 5 corresponds to the sample source-domain content node 4 and the sample source-domain content node 5.

In some embodiments, the sample source-domain semantic label node and the sample source-domain content node are in many-to-one correspondence. For example, a sample source-domain semantic label node 2 and a sample source-domain semantic label node 4 correspond to the sample source-domain content node 2, and a sample source-domain semantic label node 5 and a sample source-domain semantic label node 6 correspond to the sample source-domain content node 5.

### Second Label Bipartite Graph Between the Sample Target-Domain Content Nodes and the Sample Target-Domain Semantic Labels:

The second label bipartite graph between the sample target-domain content nodes and the sample target-domain semantic labels is constructed through a semantic label system in the target domain. The semantic label system is configured to perform semantic label modeling on a user or content, to obtain a semantic label corresponding to the user or content. For example, for a short video, a theme label, an author label, a keyword label, a character label, or the like corresponding to the short-video content is obtained through the semantic label system. The sample target-domain semantic label and the sample target-domain content node that are in correspondence are connected through the connecting edge, to obtain the second label bipartite graph between the sample target-domain content nodes and the sample target-domain semantic labels.

In some embodiments, the sample target-domain semantic label node and the sample target-domain content node are in one-to-one correspondence. For example, a sample target-domain semantic label node 2 corresponds to the sample target-domain content node 2.

In some embodiments, the sample target-domain semantic label node and the sample target-domain content node are in one-to-many correspondence. For example, a sample target-domain semantic label node 1 corresponds to the sample target-domain content node 1 and the sample target-domain content node 3, and a sample target-domain semantic label node 5 corresponds to the sample target-domain content node 5 and the sample target-domain content node 6.

In some embodiments, the sample target-domain semantic label node and the sample target-domain content node are in many-to-one correspondence. For example, a sample target-domain semantic label node 3 and a sample target-domain semantic label node 6 correspond to a sample target-domain content node 4, and a sample target-domain semantic label node 4 and a sample target-domain semantic label node 5 correspond to the sample target-domain content node 5.

### Node Bipartite Graph Between the Sample Source-Domain Content Nodes and the Sample Target-Domain Content Nodes:

The node bipartite graph between the sample source-domain content nodes and the sample target-domain content nodes is constructed based on the historical behaviors of the plurality of user accounts in the source domain and the target domain. The sample source-domain contents that historically interacted with the plurality of user accounts are determined based on the historical behaviors of the plurality of user accounts in the source domain. For example, it is determined, based on the historical behavior of clicking/tapping the short video by the user account to watch, that the sample source-domain content that historically interacted with the user account is the watched short video. The sample target-domain contents that historically interacted with the plurality of user accounts are determined based on the historical behaviors of the plurality of user accounts in the target domain. For example, it is determined, based on a historical behavior of clicking/tapping a long video by the user account to watch, that the sample target-domain content that historically interacted with the user account is the watched long video. A sample source-domain content node corresponding to the sample source-domain content and a sample target-domain content node corresponding to the sample target-domain content are connected through a connecting edge based on a quantity of co-occurrences between the sample source-domain content and the sample target-domain content in the same user account in a first period of time, to obtain the node bipartite graph between the sample source-domain content nodes and the sample target-domain content nodes. The period of time may be preset by the system or randomly adjusted according to a specific condition, and may be, for example, one minute, five minutes, or 10 minutes. Assuming that the period of time is five minutes, the historical behavior of the user account in the source domain is watching a short video, and the historical behavior of the user account in the target domain is reading news, a node bipartite graph between a short video node and a news node is constructed based on behaviors of watching the short video and reading the news by the user account within five minutes.

In some embodiments, the sample source-domain content node and the sample target-domain content node are in one-to-one correspondence. For example, the sample source-domain content node 5 corresponds to the sample target-domain content node 6.

In some embodiments, the sample source-domain content node and the sample target-domain content node are in one-to-many correspondence. For example, the sample source-domain content node 1 corresponds to the sample target-domain content node 2 and the sample target-domain content node 4, the sample source-domain content node 2 corresponds to the sample target-domain content node 1 and the sample target-domain content node 3, and the sample source-domain content node 4 corresponds to the sample target-domain content node 4 and the sample target-domain content node 5.

In some embodiments, the sample source-domain content node and the sample target-domain content node are in many-to-one correspondence. For example, the sample source-domain content node 1, the sample source-domain content node 3, and the sample source-domain content node 4 correspond to the sample target-domain content node 4.

The node bipartite graph includes a first sample source-domain content node and a first sample target-domain content node between which a connecting edge exists. For example, the sample source-domain content node 1 is used as the first sample source-domain content node, and the sample target-domain content node 2 is used as the first sample target-domain content node. In this case, a group of training samples is the sample source-domain content node 1, the sample target-domain content node 2, the sample source-domain semantic label corresponding to the sample source-domain content node 1 in the first label bipartite graph, and the sample target-domain semantic label corresponding to the sample target-domain content node 2 in the second label bipartite graph.

In some embodiments, when a second sample source-domain content node in a co-occurrence relationship with the first sample source-domain content node exists in the source-domain co-occurrence network, the training sample is generated by using the second sample source-domain content node, the first sample target-domain content node, a sample source-domain semantic label corresponding to the second sample source-domain content node in the first label bipartite graph, and a sample target-domain semantic label corresponding to the first sample target-domain content node in the second label bipartite graph. For example, the sample source-domain content node 2 and the sample source-domain content node 3 in a co-occurrence relationship with the sample source-domain content node 1 exist in the source-domain co-occurrence network 420. In this case, a group of training samples is the sample source-domain content node 2, the sample target-domain content node 2, the sample source-domain semantic label corresponding to the sample source-domain content node 2 in the first label bipartite graph, and the sample target-domain semantic label corresponding to the sample target-domain content node 2 in the second label bipartite graph, and another group of training samples is the sample source-domain content node 3, the sample target-domain content node 2, the sample source-domain semantic label corresponding to the sample source-domain content node 3 in the first label bipartite graph, and the sample target-domain semantic label corresponding to the sample target-domain content node 2 in the second label bipartite graph.

In some embodiments, when a second sample target-domain content node in a co-occurrence relationship with the first sample target-domain content node exists in the target-domain co-occurrence network, the training sample is generated by using the second sample target-domain content node, the first sample source-domain content node, a sample source-domain semantic label corresponding to the first sample source-domain content node in the first label bipartite graph, and a sample target-domain semantic label corresponding to the second sample target-domain content node in the second label bipartite graph. For example, when the sample target-domain content node 1 and the sample target-domain content node 3 in a co-occurrence relationship with the sample target-domain content node 2 exist in the target-domain co-occurrence network 440, a group of training samples is the sample source-domain content node 1, the sample target-domain content node 1, the sample source-domain semantic label corresponding to the sample source-domain content node 1 in the first label bipartite graph, and the sample target-domain semantic label corresponding to the sample target-domain content node 1 in the second label bipartite graph, and another group of training samples is the sample source-domain content node 1, the sample target-domain content node 3, the sample source-domain semantic label corresponding to the sample source-domain content node 1 in the first label bipartite graph, and the sample target-domain semantic label corresponding to the sample target-domain content node 3 in the second label bipartite graph.

In some embodiments, when a second sample source-domain content node in a co-occurrence relationship with the first sample source-domain content node exists in the source-domain co-occurrence network and a second sample target-domain content node in a co-occurrence relationship with the first sample target-domain content node exists in the target-domain co-occurrence network, the training sample is generated by using the second sample source-domain content node, the second sample target-domain content node, a sample source-domain semantic label corresponding to the second sample source-domain content node in the first label bipartite graph, and a sample target-domain semantic label corresponding to the second sample target-domain content node in the second label bipartite graph. For example, the sample source-domain content node 2 and the sample source-domain content node 3 in a co-occurrence relationship with the sample source-domain content node 1 exist in the source-domain co-occurrence network 420, and the sample target-domain content node 1 and the sample target-domain content node 3 in a co-occurrence relationship with the sample target-domain content node 2 exist in the target-domain co-occurrence network 440, a group of training samples is the sample source-domain content node 2, the sample target-domain content node 1, the sample source-domain semantic label corresponding to the sample source-domain content node 2 in the first label bipartite graph, and the sample target-domain semantic label corresponding to the sample target-domain content node 1 in the second label bipartite graph, another group of training samples is the sample source-domain content node 2, the sample target-domain content node 3, the sample source-domain semantic label corresponding to the sample source-domain content node 2 in the first label bipartite graph, and the sample target-domain semantic label corresponding to the sample target-domain content node 3 in the second label bipartite graph, still another group of training samples is the sample source-domain content node 3, the sample target-domain content node 1, the sample source-domain semantic label corresponding to the sample source-domain content node 3 in the first label bipartite graph, and the sample target-domain semantic label corresponding to the sample target-domain content node 1 in the second label bipartite graph, and yet another group of training samples is the sample source-domain content node 3, the sample target-domain content node 3, the sample source-domain semantic label corresponding to the sample source-domain content node 3 in the first label bipartite graph, and the sample target-domain semantic label corresponding to the sample target-domain content node 3 in the second label bipartite graph.

In conclusion, according to the method provided in this embodiment, the source-domain co-occurrence network and the target-domain co-occurrence network are constructed, so that a semantic relationship and a content association in the source domain and the target domain can be discovered. The first label bipartite graph between the sample source-domain content nodes and the sample source-domain semantic labels and the second label bipartite graph between the sample target-domain content nodes and the sample target-domain semantic labels are constructed, so that a relationship between the sample source-domain content node and the sample source-domain semantic label and a relationship between the sample target-domain content node and the sample target-domain semantic label can be modeled. The node bipartite graph between the sample source-domain content nodes and the sample target-domain content nodes is constructed, so that a relationship between the sample source-domain content node and the sample target-domain content node is considered. In this way, more training sample data is obtained, so that the cross-domain recommendation model can learn more data, to perform better content recommendation by using the cross-domain recommendation model.

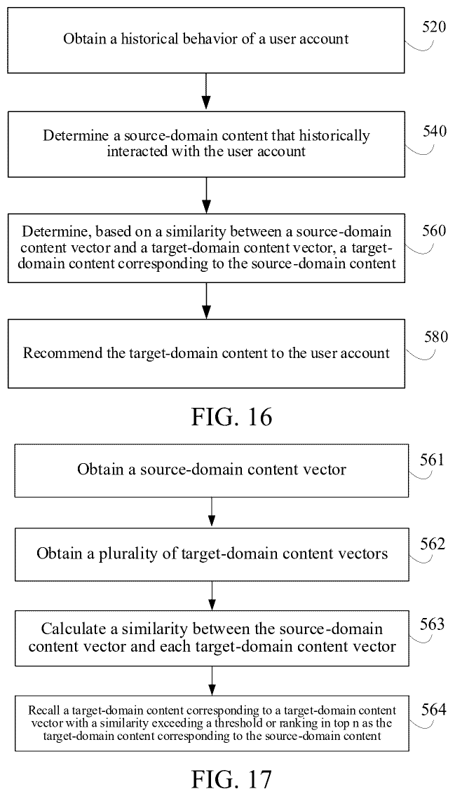

FIG. 16 is a schematic diagram of a cross-domain recommendation method according to an exemplary embodiment of the present disclosure. The method is performed by a computer device, and the computer device may be the terminal 120 or the server 140 shown in FIG. 1. The method includes the following operations:

Operation S20: Obtain a historical behavior of a user account.

The server 140 obtains the historical behavior of the user account on the terminal 120 connected to the server 140 through a wireless network or a wired network. The historical behavior includes at least one of clicking/tapping, touching, sliding, commenting, long pressing, fingerprint recognition, and facial recognition performed by the user account. All operations performed by a user on the terminal 120 by using the user account are considered as the historical behavior of the user account.

Operation S40: Determine a source-domain content that historically interacted with the user account.

The source-domain content that historically interacted with the user account is determined based on the historical behavior of the user account. For example, it is determined, based on a historical behavior of clicking/tapping a short video by the user account to watch, that the sample source-domain content that historically interacted with the user account is the watched short video.

Operation S60: Determine, based on a similarity between a source-domain content vector and a target-domain content vector, a target-domain content corresponding to the source-domain content.

The target-domain content corresponding to the source-domain content is determined based on the similarity between the source-domain content vector and the target-domain content vector. The similarity is calculated by using the foregoing cross-domain recommendation model obtained through training. The source-domain content vector is a feature vector of the source-domain content, the target-domain content vector is a feature vector of the target-domain content, the source-domain content vector is constructed based on the source-domain content and a source-domain semantic label corresponding to the source-domain content in a first label bipartite graph, and the target-domain content vector is constructed based on the target-domain content and a target-domain semantic label corresponding to the target-domain content in a second label bipartite graph. The first label bipartite graph is constructed based on the source-domain content and the source-domain semantic label, and the second label bipartite graph is constructed based on the target-domain content and the target-domain semantic label.

In some embodiments, the source-domain content and the target-domain content may be contents in a same domain. For example, both the source-domain content and the target-domain content are short-video contents or long-video contents.

In some embodiments, the source-domain content and the target-domain content may be contents in different domains. For example, the source-domain content is a short-video content, and the target-domain content is a long-video content; or the source-domain content is a long-video content, and the target-domain content is a short-video content.

Operation S80: Recommend the target-domain content to the user account.

After the server 140 determines the target-domain content corresponding to the source-domain content, the server 140 sends the target-domain content to the terminal 120, and the terminal 120 displays the target-domain content, to recommend the target-domain content to the user account based on the source-domain content corresponding to the historical behavior of the user account on the terminal 120.

In conclusion, according to the method provided in this embodiment, the source-domain content that historically interacted with the user account is determined by obtaining the historical behavior of the user account. The target-domain content corresponding to the source-domain content is determined based on the similarity between the source-domain content vector corresponding to the source-domain content and the target-domain content vector corresponding to the target-domain content, and is recommended to the user account. A preference and an interest of the user account can be obtained by using historical behavior data of the user account, to recommend the target-domain content more accurately. The target-domain content is obtained based on the source-domain content, so that a problem that a target-domain content cannot be recommended or a recommended target-domain content has a low similarity due to user data sparsity can be avoided.

FIG. 17 is a schematic diagram of a cross-domain recommendation method according to an exemplary embodiment of the present disclosure. Operation S60 further includes at least one of the following operations:

Operation S61: Obtain the source-domain content vector.

The source-domain content vector is constructed based on a first content vector and a first semantic label vector. The first content vector is a content vector corresponding to the source-domain content, and the first semantic label vector is a semantic label vector corresponding to the source-domain semantic label corresponding to the source-domain content in the first label bipartite graph. The source-domain content vector corresponding to the source-domain content is obtained from the server based on the source-domain content corresponding to the historical behavior of the user account.

Operation S62: Obtain a plurality of target-domain content vectors.

The target-domain content vector is constructed based on a second content vector and a second semantic label vector. The second content vector is a content vector corresponding to the target-domain content, and the second semantic label vector is a semantic label vector corresponding to the target-domain semantic label corresponding to the target-domain content in the second label bipartite graph. The target-domain content vector corresponding to the target-domain content is obtained from the server.

Operation S63: Calculate a similarity between the source-domain content vector and each target-domain content vector.

A plurality of similarities between the source-domain content vector of the source-domain content corresponding to the historical behavior of the user account and the plurality of target-domain content vectors are calculated. For example, the target-domain content vectors include a target-domain content vector 1, a target-domain content vector 2, and a target-domain content vector 3. In this case, a similarity 1 between the source-domain content vector and the target-domain content vector 1, a similarity 2 between the source-domain content vector and the target-domain content vector 2, and a similarity 3 between the source-domain content vector and the target-domain content vector 3 are calculated.

Operation S64: Recall a target-domain content corresponding to a target-domain content vector with a similarity exceeding a threshold or ranking in top n as the target-domain content corresponding to the source-domain content.

The target-domain content corresponding to the target-domain content vector with a similarity to the source-domain content vector exceeding the threshold or ranking in top n is recalled by using a vector search tool, and the target-domain content vector is determined as the target-domain content corresponding to the source-domain content. A value of n is a positive integer, and may be preset by a system or randomly adjusted according to a specific condition. For example, n is 1, 2, or 3. For example, n is 2. When the target-domain content vectors include the target-domain content vector 1, the target-domain content vector 2, and the target-domain content vector 3, there are the similarity 1 between the source-domain content vector and the target-domain content vector 1, the similarity 2 between the source-domain content vector and the target-domain content vector 2, and the similarity 3 between the source-domain content vector and the target-domain content vector 3. If the similarity 1 is greater than the similarity 3, and the similarity 3 is greater than the similarity 2, the target-domain content 1 and the target-domain content 3 corresponding to the source-domain content are recalled.

In conclusion, according to the method provided in this embodiment, the source-domain content vector and the plurality of target-domain content vectors are obtained, the similarity between the source-domain content vector and each target-domain content vector is calculated, and the target-domain content corresponding to the target-domain content vector with a similarity exceeding the threshold or ranking in top n is recalled as the target-domain content corresponding to the source-domain content, so that the target-domain content related to the source-domain content can be more accurately recommended. The target-domain content is obtained based on the source-domain content, so that the problem that the target-domain content cannot be recommended or the recommended target-domain content has a low similarity due to the user data sparsity can be avoided.

In some embodiments, a cross-domain recommendation model runs on the server 140, and the cross-domain recommendation model includes a source-domain semantic tower and a target-domain semantic tower. As shown in FIG. 3, a cross-domain recommendation model 300 includes a source-domain semantic tower 320 and a target-domain semantic tower 340. The source-domain semantic tower includes a source-domain node feature extraction network, a source-domain label feature extraction network, a source-domain concatenation layer, and a source-domain representation layer that are cascaded. As shown in FIG. 5, the source-domain semantic tower 320 includes a source-domain node feature extraction network 321, a source-domain label feature extraction network 322, a source-domain concatenation layer 323, and a source-domain representation layer 324 that are cascaded. An input end of the source-domain node feature extraction network 321 is connected to a source-domain content node, an output end of the source-domain node feature extraction network 321 is connected to the source-domain concatenation layer 323, an output end of the source-domain label feature extraction network 322 is connected to an input end of the source-domain concatenation layer 323, and an output end of the source-domain concatenation layer 323 is connected to an input end of the source-domain representation layer 324.

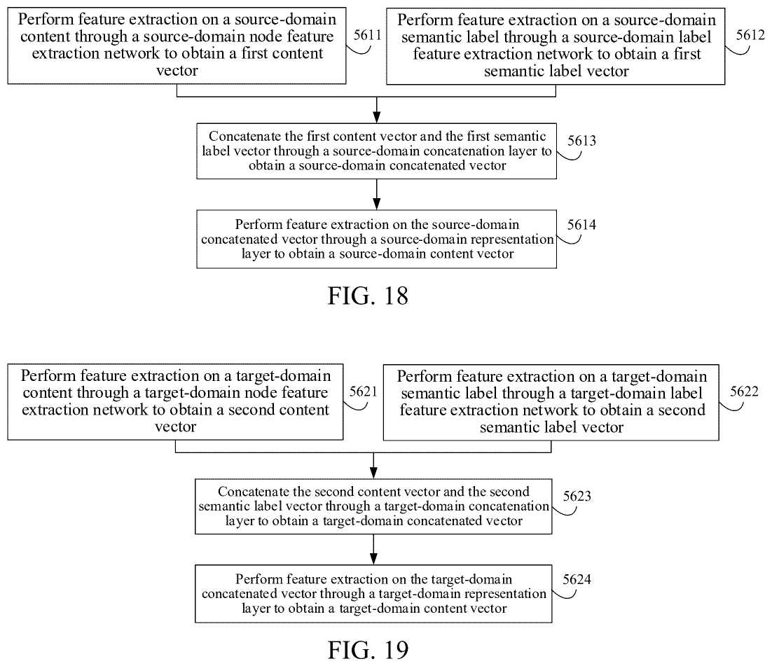

FIG. 18 is a schematic diagram of a cross-domain recommendation method according to an exemplary embodiment of the present disclosure. Operation S61 further includes at least one of the following operations:

Operation S611: Perform feature extraction on the source-domain content through the source-domain node feature extraction network to obtain the first content vector.

In some embodiments, the source-domain node feature extraction network includes a source-domain node input layer, a source-domain node embedding layer, and a source-domain node representation layer that are cascaded. As shown in FIG. 7, the source-domain node feature extraction network 321 includes a source-domain node input layer 3211, a source-domain node embedding layer 3212, and a source-domain node representation layer 3213 that are cascaded. An input end of the source-domain node input layer 3211 is connected to the source-domain content node, an output end of the source-domain node input layer 3211 is connected to an input end of the source-domain node embedding layer 3212, an output end of the source-domain node embedding layer 3212 is connected to an input end of the source-domain node representation layer 3213, and an output end of the source-domain node representation layer 3213 is connected to the input end of the source-domain concatenation layer 323.

A first content feature of the source-domain content node is inputted through the source-domain node input layer. The first content feature at the source-domain node input layer is outputted, and embedding representation is performed on the first content feature through the source-domain node embedding layer, to obtain an embedded representation vector of a first content. The embedded representation vector of the first content at the source-domain node embedding layer is outputted, and the embedded representation vector of the first content is learned through the source-domain node representation layer to obtain the first content vector.

Operation S612: Perform feature extraction on the source-domain semantic label through the source-domain label feature extraction network to obtain the first semantic label vector.

In some embodiments, the source-domain label feature extraction network includes a source-domain semantic label input layer, a source-domain embedded-representation encoder, and a source-domain label representation layer that are cascaded. As shown in FIG. 8, the source-domain label feature extraction network 322 includes a source-domain semantic label input layer 3221, a source-domain embedded-representation encoder 3222, and a source-domain label representation layer 3223 that are cascaded. An input end of the source-domain semantic label input layer 3221 is connected to the source-domain semantic label, an output end of the source-domain semantic label input layer 3221 is connected to an input end of the source-domain embedded-representation encoder 3222, an output end of the source-domain embedded-representation encoder 3222 is connected to an input end of the source-domain label representation layer 3223, and an output end of the source-domain label representation layer 3223 is connected to the input end of the source-domain concatenation layer 323.

A first semantic feature of the source-domain semantic label is inputted through the source-domain semantic label input layer. The first semantic feature at the source-domain semantic label input layer is outputted, and embedding representation is performed on the first semantic feature through the source-domain embedded-representation encoder to obtain an embedded representation vector of a first semantic label. The embedded representation vector of the first semantic label in the source-domain embedded-representation encoder is outputted, and the embedded representation vector of the first semantic label is learned through the source-domain label representation layer to obtain the first semantic label vector.

Operation S613: Concatenate the first content vector and the first semantic label vector through the source-domain concatenation layer to obtain a source-domain concatenated vector.

As shown in FIG. 9, the source-domain semantic tower 320 outputs the first content vector through the source-domain node input layer 3211, the source-domain node embedding layer 3212, and the source-domain node representation layer 3213 that are cascaded, and outputs the first semantic label vector through the source-domain semantic label input layer 3221, the source-domain embedded-representation encoder 3222, and the source-domain label representation layer 3223 that are cascaded.

The first content vector and the first semantic label vector are inputted into the source-domain concatenation layer 323, to perform vector concatenation on the first content vector and the first semantic label vector to obtain the source-domain concatenated vector.

Operation S614: Perform feature extraction on the source-domain concatenated vector through the source-domain representation layer to obtain the source-domain content vector.

As shown in FIG. 9, the source-domain concatenated vector outputted by the source-domain concatenation layer 323 is inputted into the source-domain representation layer 324 to obtain the source-domain content vector. The source-domain content vector is a complete feature vector that is of the source-domain content and that includes the source-domain content node and the source-domain semantic label corresponding to the source-domain content node.

In some embodiments, the target-domain semantic tower includes a target-domain node feature extraction network, a target-domain label feature extraction network, a target-domain concatenation layer, and a target-domain representation layer that are cascaded. As shown in FIG. 10, the target-domain semantic tower 340 includes a target-domain node feature extraction network 341, a target-domain label feature extraction network 342, a target-domain concatenation layer 343, and a target-domain representation layer 344 that are cascaded. An input end of the target-domain node feature extraction network 341 is connected to a target-domain content node, an output end of the target-domain node feature extraction network 341 is connected to the target-domain concatenation layer 343, an output end of the target-domain label feature extraction network 342 is connected to an input end of the target-domain concatenation layer 343, and an output end of the target-domain concatenation layer 343 is connected to an input end of the target-domain representation layer 344.

FIG. 19 is a schematic diagram of a cross-domain recommendation method according to an exemplary embodiment of the present disclosure. Operation S62 further includes at least one of the following operations:

Operation S621: Perform feature extraction on the target-domain content through the target-domain node feature extraction network to obtain the second content vector.

In some embodiments, the target-domain node feature extraction network includes a target-domain node input layer, a target-domain node embedding layer, and a target-domain node representation layer that are cascaded. As shown in FIG. 12, the target-domain node feature extraction network 341 includes a target-domain node input layer 3411, a target-domain node embedding layer 3412, and a target-domain node representation layer 3413 that are cascaded. An input end of the target-domain node input layer 3411 is connected to the target-domain content node, an output end of the target-domain node input layer 3411 is connected to an input end of the target-domain node embedding layer 3412, an output end of the target-domain node embedding layer 3412 is connected to an input end of the target-domain node representation layer 3413, and an output end of the target-domain node representation layer 3413 is connected to the input end of the target-domain concatenation layer 343.

A second content feature of the target-domain content node is inputted through the target-domain node input layer. The second content feature at the target-domain node input layer is outputted, and embedding representation is performed on the second content feature through the target-domain node embedding layer, to obtain an embedded representation vector of a second content. The embedded representation vector of the second content at the target-domain node embedding layer is outputted, and the embedded representation vector of the second content is learned through the target-domain node representation layer to obtain the second content vector.

Operation S622: Perform feature extraction on the target-domain semantic label through the target-domain label feature extraction network to obtain the second semantic label vector.

In some embodiments, the target-domain label feature extraction network includes a target-domain semantic label input layer, a target-domain embedded-representation encoder, and a target-domain label representation layer that are cascaded. As shown in FIG. 13, the target-domain label feature extraction network 342 includes a target-domain semantic label input layer 3421, a target-domain embedded-representation encoder 3422, and a target-domain label representation layer 3423 that are cascaded. An input end of the target-domain semantic label input layer 3421 is connected to the target-domain semantic label, an output end of the target-domain semantic label input layer 3421 is connected to an input end of the target-domain embedded-representation encoder 3422, an output end of the target-domain embedded-representation encoder 3422 is connected to an input end of the target-domain label representation layer 3423, and an output end of the target-domain label representation layer 3423 is connected to the input end of the target-domain concatenation layer 343.

A second semantic feature of the target-domain semantic label is inputted through the target-domain semantic label input layer. The second semantic feature at the target-domain semantic label input layer is outputted, and embedding representation is performed on the second semantic feature through the target-domain embedded-representation encoder to obtain an embedded representation vector of a second semantic label. The embedded representation vector of the second semantic label in the target-domain embedded-representation encoder is outputted, and the embedded representation vector of the second semantic label is learned through the target-domain label representation layer to obtain the second semantic label vector.

Operation S623: Concatenate the second content vector and the second semantic label vector through the target-domain concatenation layer to obtain a target-domain concatenated vector.

As shown in FIG. 14, the target-domain semantic tower 340 outputs the second content vector through the target-domain node input layer 3411, the target-domain node embedding layer 3412, and the target-domain node representation layer 3413 that are cascaded, and outputs the second semantic label vector through the target-domain semantic label input layer 3421, the target-domain embedded-representation encoder 3422, and the target-domain label representation layer 3423 that are cascaded.

The second content vector and the second semantic label vector are inputted into the target-domain concatenation layer 343, to perform vector concatenation on the second content vector and the second semantic label vector to obtain the target-domain concatenated vector.

Operation S624: Perform feature extraction on the target-domain concatenated vector through the target-domain representation layer to obtain the target-domain content vector.

As shown in FIG. 14, the target-domain concatenated vector outputted by the target-domain concatenation layer 343 is inputted into the target-domain representation layer 344 to obtain the target-domain content vector. The target-domain content vector is a complete feature vector that is of the target-domain content and that includes the target-domain content node and the target-domain semantic label corresponding to the target-domain content node.

In conclusion, according to the method provided in this embodiment, through the source-domain semantic tower and the target-domain semantic tower, the first content vector and the corresponding first semantic label vector are concatenated to obtain the source-domain content vector including a complete feature of the source-domain content, and the second content vector and the corresponding second semantic label vector are concatenated to obtain the target-domain content vector including a complete feature of the target-domain content. A more complete feature representation can be obtained, so that accuracy and robustness of a recommendation system are improved.

In some embodiments, the source-domain node feature extraction network includes the source-domain node input layer, the source-domain node embedding layer, and the source-domain node representation layer that are cascaded. As shown in FIG. 7, the source-domain node feature extraction network 321 includes the source-domain node input layer 3211, the source-domain node embedding layer 3212, and the source-domain node representation layer 3213 that are cascaded. The input end of the source-domain node input layer 3211 is connected to the source-domain content node, the output end of the source-domain node input layer 3211 is connected to the input end of the source-domain node embedding layer 3212, the output end of the source-domain node embedding layer 3212 is connected to the input end of the source-domain node representation layer 3213, and the output end of the source-domain node representation layer 3213 is connected to the input end of the source-domain concatenation layer 323.

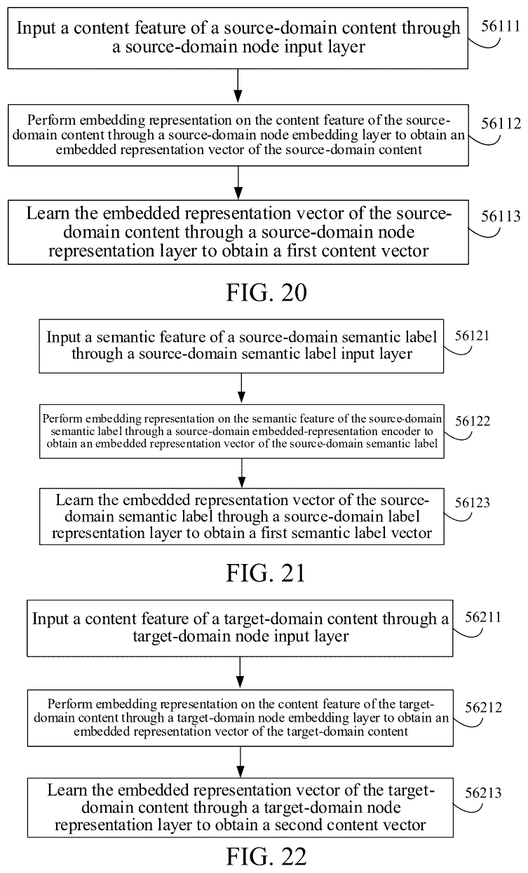

FIG. 20 is a schematic diagram of a cross-domain recommendation method according to an exemplary embodiment of the present disclosure. Operation S611 further includes at least one of the following operations:

Operation S6111: Input a content feature of the source-domain content through the source-domain node input layer.

The content feature of the source-domain content is used as an input of the source-domain node input layer, and the content feature of the source-domain content includes a feature corresponding to the source-domain content or a content attribute corresponding to the source-domain content.

For example, assuming that the source-domain content is a specific movie, the content feature of the source-domain content includes at least one of the field to which the movie belongs, a theme of the movie, and duration of the movie. For example, the movie is an action movie, or the movie is a literary movie. Assuming that the source-domain content is specific news, the content feature of the source-domain content includes at least one of an associated object of the news, the field to which the news belongs, and frequency at which the news appears. For example, the news belongs to a financial category, or the news belongs to a life category.

Operation S6112: Perform embedding representation on the content feature of the source-domain content through the source-domain node embedding layer to obtain an embedded representation vector of the source-domain content.

The content feature of the source-domain content is inputted into the source-domain node embedding layer through the source-domain node input layer, where the source-domain node embedding layer is configured for performing embedding representation on an input object, to be specific, generating a distributed representation of the input object through a neural network model. A main function is to transform high-dimensional and sparse vectors of original objects into low-dimensional and dense vectors, so that these low-dimensional and dense vectors can express one or more features of the corresponding objects. In addition, a distance between different vectors can reflect a similarity between objects. The embedding representation is performed on the content feature of the source-domain content to obtain the embedded representation vector of the source-domain content.

Operation S6113: Learn the embedded representation vector of the source-domain content through the source-domain node representation layer to obtain the first content vector.

The embedded representation vector of the source-domain content is inputted into the source-domain node representation layer, where the source-domain node representation layer is configured for learning an input object, and is usually implemented by using a plurality of fully connected layers that are superimposed. The embedded representation vector of the source-domain content is learned to obtain the first content vector.

FIG. 21 is a schematic diagram of a cross-domain recommendation method according to an exemplary embodiment of the present disclosure. Operation S612 further includes at least one of the following operations:

Operation S6121: Input a semantic feature of the source-domain semantic label through the source-domain semantic label input layer.

The semantic feature of the source-domain semantic label is used as an input of the source-domain semantic label input layer, and includes a semantic label feature corresponding to the source-domain content.

For example, assuming that the source-domain content is a specific movie, the source-domain semantic label includes at least one of a name of the movie, a character name in the movie, and a producer of the movie. Assuming that the source-domain content is specific news, the source-domain semantic label includes at least one of a title of the news, a correspondent of the news, and a keyword in the news.

Operation S6122: Perform embedding representation on the semantic feature of the source-domain semantic label through the source-domain embedded-representation encoder to obtain an embedded representation vector of the source-domain semantic label.

The semantic feature of the source-domain semantic label is inputted into the source-domain embedded-representation encoder through the source-domain semantic label input layer, and the source-domain embedded-representation encoder is configured to perform embedding representation on an input object, to be specific, generate a distributed representation of the input object through a neural network model. A main function is to transform high-dimensional and sparse vectors of original objects into low-dimensional and dense vectors, so that these low-dimensional and dense vectors can express one or more features of the corresponding objects. In addition, a distance between different vectors can reflect a similarity between objects. The embedding representation is performed on the semantic feature of the source-domain semantic label to obtain the embedded representation vector of the source-domain semantic label.

Operation S6123: Learn the embedded representation vector of the source-domain semantic label through the source-domain label representation layer to obtain the first semantic label vector.

The embedded representation vector of the source-domain semantic label is inputted into the source-domain label representation layer, where the source-domain label representation layer is configured for learning an input object, and is usually implemented by using a plurality of fully connected layers that are superimposed. The embedded representation vector of the source-domain semantic label is learned to obtain the first semantic label vector.

FIG. 22 is a schematic diagram of a cross-domain recommendation method according to an exemplary embodiment of the present disclosure. Operation S621 further includes at least one of the following operations:

Operation S6211: Input a content feature of the target-domain content through the target-domain node input layer.

The content feature of the target-domain content is used as an input of the target-domain node input layer, and the content feature of the target-domain content includes a feature corresponding to the target-domain content or a content attribute corresponding to the target-domain content.

For example, assuming that the target-domain content is a specific movie, the content feature of the target-domain content includes at least one of the field to which the movie belongs, a theme of the movie, and duration of the movie. For example, the movie is an action movie, or the movie is a literary movie. Assuming that the target-domain content is specific news, the content feature of the target-domain content includes at least one of an associated object of the news, the field to which the news belongs, and frequency at which the news appears. For example, the news belongs to a financial category, or the news belongs to a life category.

Operation S6212: Perform embedding representation on the content feature of the target-domain content through the target-domain node embedding layer to obtain an embedded representation vector of the target-domain content.

The content feature of the target-domain content is inputted into the target-domain node embedding layer through the target-domain node input layer, where the target-domain node embedding layer is configured for performing embedding representation on an input object, to be specific, generating a distributed representation of the input object through a neural network model. A main function is to transform high-dimensional and sparse vectors of original objects into low-dimensional and dense vectors, so that these low-dimensional and dense vectors can express one or more features of the corresponding objects. In addition, a distance between different vectors can reflect a similarity between objects. The embedding representation is performed on the content feature of the target-domain content to obtain the embedded representation vector of the target-domain content.

Operation S6213: Learn the embedded representation vector of the target-domain content through the target-domain node representation layer to obtain the second content vector.

The embedded representation vector of the target-domain content is inputted into the target-domain node representation layer, where the target-domain node representation layer is configured for learning an input object, and is usually implemented by using a plurality of fully connected layers that are superimposed. The embedded representation vector of the target-domain content is learned to obtain the second content vector.

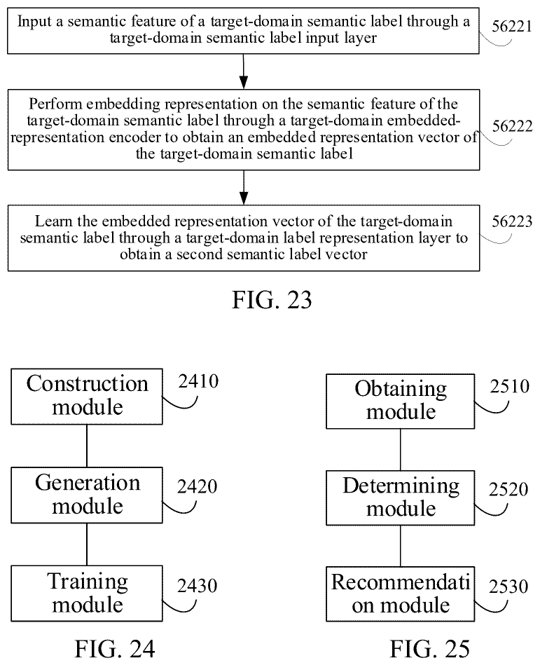

FIG. 23 is a schematic diagram of a cross-domain recommendation method according to an exemplary embodiment of the present disclosure. Operation S622 further includes at least one of the following operations:

Operation S6221: Input a semantic feature of the target-domain semantic label through the target-domain semantic label input layer.

The semantic feature of the target-domain semantic label is used as an input of the target-domain semantic label input layer, and includes a semantic label feature corresponding to the target-domain content.

For example, assuming that the target-domain content is a specific movie, the target-domain semantic label includes at least one of a name of the movie, a character name in the movie, and a producer of the movie. Assuming that the target-domain content is specific news, the target-domain semantic label includes at least one of a title of the news, a correspondent of the news, and a keyword in the news.

Operation S6222: Perform embedding representation on the semantic feature of the target-domain semantic label through the target-domain embedded-representation encoder to obtain an embedded representation vector of the target-domain semantic label.

The semantic feature of the target-domain semantic label is inputted into the target-domain embedded-representation encoder through the target-domain semantic label input layer, and the target-domain embedded-representation encoder is configured to perform embedding representation on an input object, to be specific, generate a distributed representation of the input object through a neural network model. A main function is to transform high-dimensional and sparse vectors of original objects into low-dimensional and dense vectors, so that these low-dimensional and dense vectors can express one or more features of the corresponding objects. In addition, a distance between different vectors can reflect a similarity between objects. The embedding representation is performed on the semantic feature of the target-domain semantic label to obtain the embedded representation vector of the target-domain semantic label.

Operation S6223: Learn the embedded representation vector of the target-domain semantic label through the target-domain label representation layer to obtain the second semantic label vector.

The embedded representation vector of the target-domain semantic label is inputted into the target-domain label representation layer, where the target-domain label representation layer is configured for learning an input object, and is usually implemented by using a plurality of fully connected layers that are superimposed. The embedded representation vector of the target-domain semantic label is learned to obtain the second semantic label vector.

In conclusion, according to the method provided in this embodiment, the feature extraction is performed on the inputted content and the semantic label corresponding to the content through the node input layer, the node embedding layer, the node representation layer, the semantic label input layer, the embedded-representation encoder, and the label representation layer, so that a more comprehensive and accurate content vector and semantic label vector can be obtained, and the model can fully learn the content feature of the source-domain content and the content feature of the target-domain content. In this way, an association between the content and semantic information of the content is better considered in a recommendation process, to implement better recommendation.

The embodiments of the present disclosure provide a new graph neural network model for cross-domain recommendation in which not only a topological relationship between nodes in the graph but also semantic labels associated with the nodes are introduced to enhance representation capabilities of the nodes. In addition, embedding representation capabilities of nodes in a source domain and a target domain are centrally trained to overcome impact caused by data sparsity in the source domain or the target domain. The embodiments of the present disclosure can be widely applied to a recommendation service that is based on a historical behavior of a user account, and is applicable to recommendation in a same domain, such as recommendation of a long video from a long video and recommendation of news from news, and to recommendation between different domains, such as recommendation of a short video from a long video, recommendation of a long video from a short video, recommendation of a commodity from a video, and recommendation of music from a video.

A main process of the present disclosure is as follows: A heterogeneous network from a source-domain content to a target-domain content is constructed according to a historical behavior of a user account. The heterogeneous network includes a co-occurrence network constructed based on source-domain contents, a co-occurrence network constructed based on target-domain contents, a label bipartite graph between a source-domain content node and a semantic label corresponding to the source-domain content, a label bipartite graph between a target-domain content node and a semantic label corresponding to the target-domain content, and a node bipartite graph between the source-domain content node and the target-domain content node.

Using a source-domain video co-occurrence network as an example of the source-domain co-occurrence network, videos watched by each user in a source domain are sorted according to watching time. Further, a video co-occurrence time window, for example, 10 minutes or 20 minutes, is preset, and it is assumed that all video contents watched by a same user in a same time window have a given similarity. The co-occurrence network is constructed for video browsing sequences of all users according to the time window. For videos of a same user within a same time window, if there is no edge, the videos are connected through an edge; and if there is already an edge, a weight on the edge is continuously accumulated. Then, a co-occurrence edge of all the users and a quantity of co-occurrences of the edge are accumulated, to obtain an entire source-domain video co-occurrence network. Finally, to filter out an edge between videos with low correlation, a threshold of the co-occurrence weight is set, for example, to three times, so that the source-domain video co-occurrence network is obtained. The target-domain co-occurrence network can be constructed by using a same method as the source-domain co-occurrence network, except that if a historical behavior of a user account in a target domain is sparse, a co-occurrence threshold may be adjusted without being consistent with the threshold in the source domain. In some embodiments, a quantity of all users in the co-occurrence network are in a scale of thousands or millions.

After the source-domain co-occurrence network and the target-domain co-occurrence network are constructed, an embedded representation of the node in the co-occurrence network may be obtained by using a common embedding representation algorithm.

The label bipartite graph only requires to associate the source-domain content node and the target-domain content node with existing semantic labels corresponding to the content nodes in a recommendation system. An embedded representation of the semantic label may be obtained by using a common word embedding method. The related method has been mentioned in many documents about natural language processing (NLP) technologies, and details are not described herein.

For the node bipartite graph, users who browse both the source-domain content and the target-domain content are selected, and contents browsed by each user are sorted according to time, to obtain a content sequence. The content sequence includes both the source-domain content and the target-domain content. For two adjacent contents in the content sequence, if one belong to the source domain and the other belongs to the target domain, the two cross-domain nodes are connected through an edge, and a co-occurrence weight on the edge is accumulated. The bipartite graph is subsequently used as a positive sample for training a cross-domain recommendation model, and a negative sample for the cross-domain recommendation model is obtained through random negative sampling.

After the heterogeneous network is constructed, a graph neural network model from the source domain to the target domain, namely, the cross-domain recommendation model described in the embodiments of the present disclosure, is constructed in the present disclosure for learning correlation between the source-domain content and the target-domain content, to finally obtain embedded representations of the source-domain content node and the target-domain content node.

A main structure of the cross-domain recommendation model includes a source-domain semantic tower and a target-domain semantic tower, where structures of the source-domain semantic tower and the target-domain semantic tower are the same. Therefore, the source-domain semantic tower is introduced as an example.

A set of nodes and a set of semantic labels associated with the nodes are respectively inputted through a node input layer and a semantic label input layer. Identified nodes and semantic labels are inputted through the node input layer and the semantic label input layer, so that embedded vectors can be obtained through a node embedding layer and an embedded-representation encoder for related features. The node is mapped into a low-dimensional and dense embedded representation through the node embedding layer to be provided to a subsequent deep learning network. A text feature vector of the semantic label connected to the content node is mapped into a low-dimensional and dense embedded representation through the embedded-representation encoder to be provided to the subsequent deep learning network. The node embedding layer and the embedded-representation encoder may be any type of recurrent neural network (RNN), or may be superposition and combination of multiple layers. A node representation layer and a semantic label representation layer are respectively configured for learning the embedded representation vectors, of the node set and the semantic label set, inputted by the node embedding layer and the embedded-representation encoder, and are usually implemented by using a plurality of fully connected layers that are superimposed. A function of a concatenation layer is to concatenate a semantic representation of a node and a graph embedded representation of the node, to obtain a complete embedded representation of the node.

After the cross-domain recommendation model is completely trained, the embedded representations of the source-domain content and the target-domain content may be extracted through the source-domain semantic tower and the target-domain semantic tower respectively. Then, a target vector close to each content vector is recalled through a vector search tool, to implement cross-domain recommendation.

The embodiments of the present disclosure have at least the following beneficial effects:

The present disclosure provides a lightweight cross-domain recommendation model. Embedded representations of content nodes in co-occurrence graphs of respective domains and semantic labels associated with the nodes are introduced to enhance representation capabilities of the corresponding nodes and improve accuracy of the cross-domain recommendation model. In addition, an embedding representation capability of a target-domain node with sparse data is trained by using a separate semantic tower, so that impact caused by a problem of data sparsity in the target domain can be greatly overcome. The present disclosure does not require that the semantic labels of the source-domain node and the target-domain node are in same feature space, so that the present disclosure can be widely applied to cross-domain recommendation in which the source domain and the target domain are different domains.

FIG. 24 is a block diagram of a cross-domain recommendation model training apparatus according to an exemplary embodiment of the present disclosure. The apparatus includes:
a construction module 2410, configured to construct a heterogeneous network, the heterogeneous network including a node bipartite graph between sample source-domain content nodes and sample target-domain content nodes, a first label bipartite graph between the sample source-domain content nodes and sample source-domain semantic labels, and a second label bipartite graph between the sample target-domain content node and sample target-domain semantic labels;
a generation module 2420, configured to generate a training sample based on a sample source-domain content node and a sample target-domain content node between which a connecting edge exists in the node bipartite graph, a sample source-domain semantic label corresponding to the sample source-domain content node in the first label bipartite graph, and a sample target-domain semantic label corresponding to the sample target-domain content node in the second label bipartite graph; and
a training module 2430, configured to train a cross-domain recommendation model based on the training sample.

The cross-domain recommendation model includes a source-domain semantic tower, a target-domain semantic tower, and a matching layer.

The training module 2430 is further configured to: for any training sample, input the sample source-domain content node and the sample source-domain semantic label corresponding to the sample source-domain content node into the source-domain semantic tower to obtain a sample source-domain content vector.

The training module 2430 is further configured to input the sample target-domain content node and the sample target-domain semantic label corresponding to the sample target-domain content node into the target-domain semantic tower to obtain a sample target-domain content vector.

The training module 2430 is further configured to input the sample source-domain content vector and the sample target-domain content vector into the matching layer to obtain a predicted similarity.

The training module 2430 is further configured to calculate an error loss between the predicted similarity and a real sample similarity.

The training module 2430 is further configured to train the cross-domain recommendation model based on the error loss.

The source-domain semantic tower includes a source-domain node feature extraction network, a source-domain label feature extraction network, a source-domain concatenation layer, and a source-domain representation layer that are cascaded, and the target-domain semantic tower includes a target-domain node feature extraction network, a target-domain label feature extraction network, a target-domain concatenation layer, and a target-domain representation layer that are cascaded.

The training module 2430 is further configured to input the sample source-domain content node into the source-domain node feature extraction network to obtain a first sample content vector.

The training module 2430 is further configured to input the sample source-domain semantic label into the source-domain label feature extraction network to obtain a first sample semantic label vector.

The training module 2430 is further configured to input the first sample content vector and the first sample semantic label vector into the source-domain concatenation layer to obtain a sample source-domain concatenated vector.

The training module 2430 is further configured to input the sample source-domain concatenated vector into the source-domain representation layer to obtain the sample source-domain content vector.

The training module 2430 is further configured to: input the sample target-domain content node into the target-domain node feature extraction network to obtain a second sample content vector; and input the sample target-domain semantic label into the target-domain label feature extraction network to obtain a second sample semantic label vector.

The training module 2430 is further configured to input the second sample content vector and the second sample semantic label vector into the target-domain concatenation layer to obtain a sample target-domain concatenated vector.

The training module 2430 is further configured to input the sample target-domain concatenated vector into the target-domain representation layer to obtain the sample target-domain content vector.

The generation module 2420 is further configured to determine the sample source-domain content nodes and the corresponding sample source-domain semantic labels in the first label bipartite graph as sample source-domain data.

The generation module 2420 is further configured to determine the sample target-domain content node and the corresponding target-domain semantic label in the second label bipartite graph as sample target-domain data.

The generation module 2420 is further configured to determine a real sample similarity between the sample source-domain data and the sample target-domain data based on a weight on the connecting edge, where the weight is determined based on a quantity of co-occurrences between the sample source-domain content node and the sample target-domain content node in a period of time.

The generation module 2420 is further configured to determine the sample source-domain data and the sample target-domain data as the training sample.

The heterogeneous network further includes a source-domain co-occurrence network constructed based on sample source-domain content nodes in a co-occurrence relationship and a target-domain co-occurrence network constructed based on sample target-domain content nodes in a co-occurrence relationship.

The node bipartite graph includes a first sample source-domain content node and a first sample target-domain content node between which a connecting edge exists.

The generation module 2420 is further configured to: when a second sample source-domain content node in a co-occurrence relationship with the first sample source-domain content node exists in the source-domain co-occurrence network, generate the training sample by using the second sample source-domain content node, the first sample target-domain content node, a sample source-domain semantic label corresponding to the second sample source-domain content node in the first label bipartite graph, and a sample target-domain semantic label corresponding to the first sample target-domain content node in the second label bipartite graph.

The generation module 2420 is further configured to: when a second sample target-domain content node in a co-occurrence relationship with the first sample target-domain content node exists in the target-domain co-occurrence network, generate the training sample by using the first sample source-domain content node, the second sample target-domain content node, a sample source-domain semantic label corresponding to the first sample source-domain content node in the first label bipartite graph, and a sample target-domain semantic label corresponding to the second sample target-domain content node in the second label bipartite graph.

The generation module 2420 is further configured to: when a second sample source-domain content node in a co-occurrence relationship with the first sample source-domain content node exists in the source-domain co-occurrence network and a second sample target-domain content node in a co-occurrence relationship with the first sample target-domain content node exists in the target-domain co-occurrence network, generate the training sample by using the second sample source-domain content node, the second sample target-domain content node, a sample source-domain semantic label corresponding to the second sample source-domain content node in the first label bipartite graph, and a sample target-domain semantic label corresponding to the second sample target-domain content node in the second label bipartite graph.

The construction module 2410 is configured to construct the first label bipartite graph between the sample source-domain content nodes and the sample source-domain semantic labels through a semantic label system in a source domain.

The construction module 2410 is further configured to construct the second label bipartite graph between the sample target-domain content nodes and the sample target-domain semantic labels through a semantic label system in a target domain.

The construction module 2410 is further configured to construct the node bipartite graph between the sample source-domain content nodes and the sample target-domain content nodes based on historical behaviors of a plurality of user accounts in the source domain and the target domain.

The construction module 2410 is further configured to obtain the sample source-domain semantic label through the semantic label system in the source domain.

The construction module 2410 is further configured to connect the sample source-domain semantic label and the sample source-domain content node that are in correspondence through a connecting edge, to obtain the first label bipartite graph between the sample source-domain content nodes and the sample source-domain semantic labels.

The construction module 2410 is further configured to obtain the sample target-domain semantic label through the semantic label system in the target domain.

The construction module 2410 is further configured to connect, through a connecting edge, the sample target-domain semantic label and the sample target-domain content node that are in correspondence, to obtain the second label bipartite graph between the sample target-domain content nodes and the sample target-domain semantic labels.

The construction module 2410 is further configured to determine, based on the historical behaviors of the plurality of user accounts in the source domain, a sample source-domain content that historically interacted with the plurality of user accounts.

The construction module 2410 is further configured to determine, based on the historical behaviors of the plurality of user accounts in the target domain, a sample target-domain content that historically interacted with the plurality of user accounts.

The construction module 2410 is further configured to connect, through a connecting edge based on a quantity of co-occurrences between the sample source-domain content and the sample target-domain content in a same user account in a first period of time, a sample source-domain content node corresponding to the sample source-domain content and a sample target-domain content node corresponding to the sample target-domain content, to obtain the node bipartite graph between the sample source-domain content nodes and the sample target-domain content nodes.

The construction module 2410 is further configured to construct a source-domain co-occurrence network based on the historical behaviors of the plurality of user accounts in the source domain.

The construction module 2410 is further configured to construct a target-domain co-occurrence network based on the historical behaviors of the plurality of user accounts in the target domain.

The construction module 2410 is further configured to determine, based on the historical behaviors of the plurality of user accounts in the source domain, sample source-domain contents that historically interacted with the plurality of user accounts.

The construction module 2410 is further configured to connect, through a connecting edge based on a quantity of co-occurrences between sample source-domain contents in a same user account in a second period of time, sample source-domain content nodes corresponding to the sample source-domain contents, to obtain the source-domain co-occurrence network.

The construction module 2410 is further configured to determine, based on the historical behaviors of the plurality of user accounts in the target domain, sample target-domain contents that historically interacted with the plurality of user accounts.

The construction module 2410 is further configured to connect, through a connecting edge based on a quantity of co-occurrences between sample target-domain contents in a same user account in a third period of time, sample target-domain content nodes corresponding to the sample target-domain contents, to obtain the target-domain co-occurrence network.

FIG. 25 is a block diagram of a cross-domain recommendation apparatus according to an exemplary embodiment of the present disclosure. The apparatus includes:
an obtaining module 2510, configured to obtain a historical behavior of a user account;
a determining module 2520, configured to determine, based on the historical behavior of the user account, a source-domain content that historically interacted with the user account,
the determining module 2520 being further configured to determine, based on a similarity between a source-domain content vector and a target-domain content vector, a target-domain content corresponding to the source-domain content; and
a recommendation module 2530, configured to recommend the target-domain content to the user account.

The source-domain content vector is a feature vector of the source-domain content, the target-domain content vector is a feature vector of the target-domain content, the source-domain content vector is constructed based on the source-domain content and a source-domain semantic label corresponding to the source-domain content in a first label bipartite graph, the target-domain content vector is constructed based on the target-domain content and a target-domain semantic label corresponding to the target-domain content in a second label bipartite graph, the first label bipartite graph is constructed based on the source-domain content and the source-domain semantic label, and the second label bipartite graph is constructed based on the target-domain content and the target-domain semantic label.

The determining module 2520 is further configured to obtain the source-domain content vector, where the source-domain content vector is constructed based on a first content vector and a first semantic label vector, the first content vector is a content vector corresponding to the source-domain content, and the first semantic label vector is a semantic label vector corresponding to the source-domain semantic label corresponding to the source-domain content in the first label bipartite graph.

The determining module 2520 is further configured to obtain a plurality of target-domain content vectors, where the target-domain content vector is constructed based on a second content vector and a second semantic label vector, the second content vector is a content vector corresponding to the target-domain content, and the second semantic label vector is a semantic label vector corresponding to the target-domain semantic label corresponding to the target-domain content in the second label bipartite graph.

The determining module 2520 is further configured to calculate a similarity between the source-domain content vector and each target-domain content vector.

The determining module 2520 is further configured to recall a target-domain content corresponding to a target content vector with a similarity exceeding a threshold or ranking in top n as the target-domain content corresponding to the source-domain content. A value of n is a positive integer.

A cross-domain recommendation model runs on a server, and the cross-domain recommendation model includes a source-domain semantic tower and a target-domain semantic tower. The source-domain semantic tower includes a source-domain node feature extraction network, a source-domain label feature extraction network, a source-domain concatenation layer, and a source-domain representation layer, and the target-domain semantic tower includes a target-domain node feature extraction network, a target-domain label feature extraction network, a target-domain concatenation layer, and a target-domain representation layer.

The determining module 2520 is further configured to perform feature extraction on the source-domain content through the source-domain node feature extraction network to obtain the first content vector.

The determining module 2520 is further configured to perform feature extraction on the source-domain semantic label through the source-domain label feature extraction network to obtain the first semantic label vector.

The determining module 2520 is further configured to concatenate the first content vector and the first semantic label vector through the source-domain concatenation layer to obtain a source-domain concatenated vector.

The determining module 2520 is further configured to perform feature extraction on the source-domain concatenated vector through the source-domain representation layer to obtain the source-domain content vector.

The determining module 2520 is further configured to: perform feature extraction on the target-domain content through the target-domain node feature extraction network to obtain the second content vector; and perform feature extraction on the target-domain semantic label through the target-domain label feature extraction network to obtain the second semantic label vector.

The determining module 2520 is further configured to concatenate the second content vector and the second semantic label vector through the target-domain concatenation layer to obtain a target-domain concatenated vector.

The determining module 2520 is further configured to perform feature extraction on the target-domain concatenated vector through the target-domain representation layer to obtain the target-domain content vector.

The source-domain node feature extraction network includes a source-domain node input layer, a source-domain node embedding layer, and a source-domain node representation layer that are cascaded, and the source-domain label feature extraction network includes a source-domain semantic label input layer, a source-domain embedded-representation encoder, and a source-domain label representation layer that are cascaded.

The determining module 2520 is further configured to input a content feature of the source-domain content through the source-domain node input layer.

The determining module 2520 is further configured to perform embedding representation on the content feature of the source-domain content through the source-domain node embedding layer to obtain an embedded representation vector of the source-domain content.

The determining module 2520 is further configured to learn the embedded representation vector of the source-domain content through the source-domain node representation layer to obtain the first content vector.

The determining module 2520 is further configured to input a semantic feature of the source-domain semantic label through the source-domain semantic label input layer.

The determining module 2520 is further configured to perform embedding representation on the semantic feature of the source-domain semantic label through the source-domain embedded-representation encoder to obtain an embedded representation vector of the source-domain semantic label.

The determining module 2520 is further configured to learn the embedded representation vector of the source-domain semantic label through the source-domain label representation layer to obtain the first semantic label vector.

The target-domain node feature extraction network includes a target-domain node input layer, a target-domain node embedding layer, and a target-domain node representation layer that are cascaded, and the target-domain label feature extraction network includes a target-domain semantic label input layer, a target-domain embedded-representation encoder, and a target-domain label representation layer that are cascaded.

The determining module 2520 is further configured to input a content feature of the target-domain content through the target-domain node input layer.

The determining module 2520 is further configured to perform embedding representation on the content feature of the target-domain content through the target-domain node embedding layer to obtain an embedded representation vector of the target-domain content.

The determining module 2520 is further configured to learn the embedded representation vector of the target-domain content through the target-domain node representation layer to obtain the second content vector.

The determining module 2520 is further configured to input a semantic feature of the target-domain semantic label through the target-domain semantic label input layer.

The determining module 2520 is further configured to perform embedding representation on the semantic feature of the target-domain semantic label through the target-domain embedded-representation encoder to obtain an embedded representation vector of the target-domain semantic label.

The determining module 2520 is further configured to learn the embedded representation vector of the target-domain semantic label through the target-domain label representation layer to obtain the second semantic label vector.

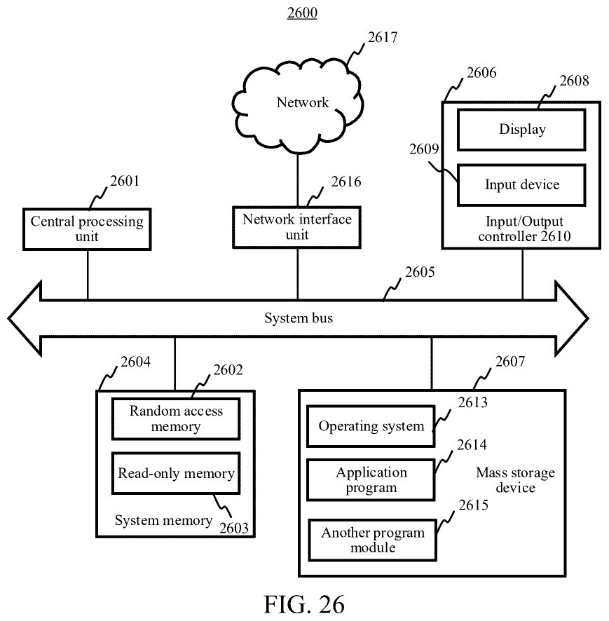

FIG. 26 is a schematic diagram of a structure of a computer device according to an exemplary embodiment of the present disclosure. The computer device may be a terminal or a server. For example, the computer device 2600 includes a central processing unit (CPU) 2601, a system memory 2604 including a random access memory (RAM) 2602 and a read-only memory (ROM) 2603, and a system bus 2605 connecting the system memory 2604 and the CPU 2601. The computer device 2600 further includes a basic input/output (I/O) system 2606 assisting in information transmission between components in the computer and a mass storage device 2607 configured to store an operating system 2613, a client 2614, and another program module 2615.

In some embodiments, the basic I/O system 2606 includes a display 2608 configured to display information and an input device 2609, for example, a mouse and a keyboard, configured to input information by a user. The display 2608 and the input device 2609 are both connected to the CPU 2601 through an I/O controller 2610 connected to the system bus 2605. The basic I/O system 2606 may further include the I/O controller 2610 configured to receive and process inputs from a plurality of other devices such as a keyboard, a mouse, or an electronic stylus. Similarly, the input/output controller 2610 further provides an output to a display screen, a printer, or another type of output device.

The mass storage device 2607 is connected to the CPU 2601 through a mass storage controller (not shown) connected to the system bus 2605. The mass storage device 2607 and a computer-readable medium associated with the mass storage device provide non-volatile storage for the computer device 2600. In other words, the mass storage device 2607 may include a computer-readable medium (not shown) such as a hard disk or a compact disc read-only memory (CD-ROM) drive.

The computer-readable medium may include a computer storage medium and a communication medium. The computer storage medium includes volatile and non-volatile media and removable and non-removable media implemented by using any method or technology for storing information such as computer-readable instructions, data structures, program modules, or other data. The computer storage medium includes a RAM, a ROM, an erasable programmable ROM (EPROM), an electrically erasable programmable ROM (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in the art may learn that the computer storage medium is not limited to the foregoing several types. The system memory 2604 and the mass storage device 2607 may be collectively referred to as a memory.

According to the embodiments of the present disclosure, the computer device 2600 may further be connected, through a network such as the Internet, to a remote computer on the network to run. That is, the computer device 2600 may be connected to a network 2617 through a network interface unit 2616 connected to the system bus 2605, or may be connected to another type of network or a remote computer system (not shown) through the network interface unit 2616.

An exemplary embodiment of the present disclosure further provides a computer-readable storage medium. The computer-readable storage medium has at least one program stored therein, and the at least one program is loaded and executed by a processor to implement the cross-domain recommendation model training method and the cross-domain recommendation method provided in the foregoing method embodiments.

An exemplary embodiment of the present disclosure further provides a computer program product. The computer program product includes at least one program, and the at least one program is stored in a readable storage medium. A processor of a communication device reads signaling from the readable storage medium, and the processor executes the signaling to cause the communication device to implement the cross-domain recommendation model training method and the cross-domain recommendation method provided in the foregoing method embodiments.

“Plurality of” mentioned in this specification means two or more. After considering this specification and practicing the present disclosure, a person skilled in the art may easily conceive of other implementations of the present disclosure. The present disclosure is intended to cover any variations, uses, or adaptive changes of the present disclosure. These variations, uses, or adaptive changes follow the general principles of the present disclosure and include common general knowledge or common technical means in the art, which are not disclosed in the present disclosure. This specification and the embodiments are considered to be merely exemplary, and the scope and spirit of the present disclosure are pointed out in the following claims.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A cross-domain recommendation model training method, the method comprising:
constructing a heterogeneous network, the heterogeneous network comprising a node bipartite graph between sample source-domain content nodes and sample target-domain content nodes, a first label bipartite graph between the sample source-domain content nodes and sample source-domain semantic labels, and a second label bipartite graph between the sample target-domain content node and sample target-domain semantic labels;
generating a plurality of training samples based on the heterogeneous network, a training sample being generated based on a sample source-domain content node and a sample target-domain content node between which a connecting edge exists in the node bipartite graph, a sample source-domain semantic label corresponding to the sample source-domain content node in the first label bipartite graph, and a sample target-domain semantic label corresponding to the sample target-domain content node in the second label bipartite graph; and
training a cross-domain recommendation model based on the plurality of training samples.

2. The method according to claim 1, wherein the cross-domain recommendation model comprises a source-domain semantic tower, a target-domain semantic tower, and a matching layer; and
the training a cross-domain recommendation model based on the training sample comprises:
for a training sample, inputting the sample source-domain content node and the sample source-domain semantic label corresponding to the sample source-domain content node into the source-domain semantic tower to obtain a sample source-domain content vector; and inputting the sample target-domain content node and the sample target-domain semantic label corresponding to the sample target-domain content node into the target-domain semantic tower to obtain a sample target-domain content vector;
inputting the sample source-domain content vector and the sample target-domain content vector into the matching layer to obtain a predicted similarity;
calculating an error loss between the predicted similarity and a real sample similarity; and
training the cross-domain recommendation model based on the error loss.

3. The method according to claim 2, wherein the source-domain semantic tower comprises a source-domain node feature extraction network, a source-domain label feature extraction network, a source-domain concatenation layer, and a source-domain representation layer that are cascaded, and the target-domain semantic tower comprises a target-domain node feature extraction network, a target-domain label feature extraction network, a target-domain concatenation layer, and a target-domain representation layer that are cascaded;
the inputting the sample source-domain content node and the sample source-domain semantic label corresponding to the sample source-domain content node into the source-domain semantic tower to obtain a sample source-domain content vector comprises:
inputting the sample source-domain content node into the source-domain node feature extraction network to obtain a first sample content vector; and inputting the sample source-domain semantic label into the source-domain label feature extraction network to obtain a first sample semantic label vector;
inputting the first sample content vector and the first sample semantic label vector into the source-domain concatenation layer to obtain a sample source-domain concatenated vector; and
inputting the sample source-domain concatenated vector into the source-domain representation layer to obtain the sample source-domain content vector; and
the inputting the sample target-domain content node and the sample target-domain semantic label corresponding to the sample target-domain content node into the target-domain semantic tower to obtain a sample target-domain content vector comprises:
inputting the sample target-domain content node into the target-domain node feature extraction network to obtain a second sample content vector; and inputting the sample target-domain semantic label into the target-domain label feature extraction network to obtain a second sample semantic label vector;
inputting the second sample content vector and the second sample semantic label vector into the target-domain concatenation layer to obtain a sample target-domain concatenated vector; and
inputting the sample target-domain concatenated vector into the target-domain representation layer to obtain the sample target-domain content vector.

4. The method according to claim 1, wherein the generating a training sample based on a sample source-domain content node and a sample target-domain content node between which a connecting edge exists in the node bipartite graph, a sample source-domain semantic label corresponding to the sample source-domain content node in the first label bipartite graph, and a sample target-domain semantic label corresponding to the sample target-domain content node in the second label bipartite graph comprises:
determining the sample source-domain content nodes and the corresponding sample source-domain semantic labels in the first label bipartite graph as sample source-domain data; and
determining the sample target-domain content nodes and the corresponding sample target-domain semantic labels in the second label bipartite graph as sample target-domain data;
determining a real sample similarity between the sample source-domain data and the sample target-domain data based on a weight on the connecting edge, wherein the weight is determined based on a quantity of co-occurrences between the sample source-domain content node and the sample target-domain content node in a period of time; and
determining the sample source-domain data, the sample target-domain data, and the real sample similarity as the training sample.

5. The method according to claim 1, wherein the heterogeneous network further comprises:
a source-domain co-occurrence network constructed based on sample source-domain content nodes in a co-occurrence relationship and a target-domain co-occurrence network constructed based on sample target-domain content nodes in a co-occurrence relationship; and
the node bipartite graph comprises a first sample source-domain content node and a first sample target-domain content node between which a connecting edge exists, and the method further comprises:
when a second sample source-domain content node in a co-occurrence relationship with the first sample source-domain content node exists in the source-domain co-occurrence network, generating a training sample by using the second sample source-domain content node, the first sample target-domain content node, a sample source-domain semantic label corresponding to the second sample source-domain content node in the first label bipartite graph, and a sample target-domain semantic label corresponding to the first sample target-domain content node in the second label bipartite graph;
when a second sample target-domain content node in a co-occurrence relationship with the first sample target-domain content node exists in the target-domain co-occurrence network, generating a training sample by using the first sample source-domain content node, the second sample target-domain content node, a sample source-domain semantic label corresponding to the first sample source-domain content node in the first label bipartite graph, and a sample target-domain semantic label corresponding to the second sample target-domain content node in the second label bipartite graph; or
when a second sample source-domain content node in a co-occurrence relationship with the first sample source-domain content node exists in the source-domain co-occurrence network, and a second sample target-domain content node in a co-occurrence relationship with the first sample target-domain content node exists in the target-domain co-occurrence network, generating a training sample by using the second sample source-domain content node, the second sample target-domain content node, a sample source-domain semantic label corresponding to the second sample source-domain content node in the first label bipartite graph, and a sample target-domain semantic label corresponding to the second sample target-domain content node in the second label bipartite graph.

6. The method according to claim 1, further comprising:
constructing the first label bipartite graph between the sample source-domain content nodes and the sample source-domain semantic labels through a semantic label system in a source domain;
constructing the second label bipartite graph between the sample target-domain content nodes and the sample target-domain semantic labels through a semantic label system in a target domain; and
constructing the node bipartite graph between the sample source-domain content nodes and the sample target-domain content nodes based on historical behaviors of a plurality of user accounts in the source domain and the target domain.

7. The method according to claim 6, wherein the constructing the first label bipartite graph between the sample source-domain content nodes and the sample source-domain semantic labels through a semantic label system in a source domain comprises:
obtaining the sample source-domain semantic label through the semantic label system in the source domain; and
connecting, through a connecting edge, the sample source-domain semantic label and the sample source-domain content node that are in correspondence, to obtain the first label bipartite graph between the sample source-domain content nodes and the sample source-domain semantic labels.

8. The method according to claim 6, wherein the constructing the second label bipartite graph between the sample target-domain content nodes and the sample target-domain semantic labels through a semantic label system in a target domain comprises:
obtaining the sample target-domain semantic label through the semantic label system in the target domain; and
connecting, through a connecting edge, the sample target-domain semantic label and the sample target-domain content node that are in correspondence, to obtain the second label bipartite graph between the sample target-domain content nodes and the sample target-domain semantic labels.

9. The method according to claim 6, wherein the constructing the node bipartite graph between the sample source-domain content nodes and the sample target-domain content nodes based on historical behaviors of a plurality of user accounts in the source domain and the target domain comprises:
determining, based on the historical behaviors of the plurality of user accounts in the source domain, a sample source-domain content that historically interacted with the plurality of user accounts;
determining, based on the historical behaviors of the plurality of user accounts in the target domain, a sample target-domain content that historically interacted with the plurality of user accounts; and
connecting, through a connecting edge based on a quantity of co-occurrences between the sample source-domain content and the sample target-domain content in a same user account in a first period of time, a sample source-domain content node corresponding to the sample source-domain content and a sample target-domain content node corresponding to the sample target-domain content, to obtain the node bipartite graph between the sample source-domain content nodes and the sample target-domain content nodes.

10. The method according to claim 6, further comprising:
constructing a source-domain co-occurrence network based on the historical behaviors of the plurality of user accounts in the source domain; and
constructing a target-domain co-occurrence network based on the historical behaviors of the plurality of user accounts in the target domain.

11. A cross-domain recommendation method, the method comprising:
obtaining a historical behavior of a user account;
determining, based on the historical behavior of the user account, a source-domain content that historically interacted with the user account;
determining, based on a similarity between a source-domain content vector and a target-domain content vector, a target-domain content corresponding to the source-domain content; and
recommending the target-domain content to the user account,
the source-domain content vector being a feature vector of the source-domain content, the target-domain content vector being a feature vector of the target-domain content, the source-domain content vector being constructed based on the source-domain content and a source-domain semantic label corresponding to the source-domain content in a first label bipartite graph, the target-domain content vector being constructed based on the target-domain content and a target-domain semantic label corresponding to the target-domain content in a second label bipartite graph, the first label bipartite graph being constructed based on source-domain contents and source-domain semantic labels, and the second label bipartite graph being constructed based on target-domain contents and target-domain semantic labels.

12. The method according to claim 11, wherein the determining, based on a similarity between a source-domain content vector and a target-domain content vector, a target-domain content corresponding to the source-domain content comprises:
obtaining the source-domain content vector, wherein the source-domain content vector is constructed based on a first content vector and a first semantic label vector, the first content vector is a content vector corresponding to the source-domain content, and the first semantic label vector is a semantic label vector corresponding to the source-domain semantic label corresponding to the source-domain content in the first label bipartite graph;
obtaining a plurality of target-domain content vectors, wherein the target-domain content vector is constructed based on a second content vector and a second semantic label vector, the second content vector is a content vector corresponding to the target-domain content, and the second semantic label vector is a semantic label vector corresponding to the target-domain semantic label corresponding to the target-domain content in the second label bipartite graph;
calculating a similarity between the source-domain content vector and each target-domain content vector; and
recalling a target-domain content corresponding to a target-domain content vector with a similarity exceeding a threshold or ranking in top n as the target-domain content corresponding to the source-domain content, wherein
a value of n is a positive integer.

13. The method according to claim 12, wherein a cross-domain recommendation model runs on a server, and the cross-domain recommendation model comprises a source-domain semantic tower and a target-domain semantic tower; and the source-domain semantic tower comprises a source-domain node feature extraction network, a source-domain label feature extraction network, a source-domain concatenation layer, and a source-domain representation layer, and the target-domain semantic tower comprises a target-domain node feature extraction network, a target-domain label feature extraction network, a target-domain concatenation layer and a target-domain representation layer;
the obtaining the source-domain content vector comprises:
performing feature extraction on the source-domain content through the source-domain node feature extraction network to obtain the first content vector; and performing feature extraction on the source-domain semantic label through the source-domain label feature extraction network to obtain the first semantic label vector;
concatenating the first content vector and the first semantic label vector through the source-domain concatenation layer to obtain a source-domain concatenated vector; and
performing feature extraction on the source-domain concatenated vector through the source-domain representation layer to obtain the source-domain content vector; and
the obtaining the plurality of target-domain content vector comprises, for one target-domain content vector:
performing feature extraction on the target-domain content through the target-domain node feature extraction network to obtain the second content vector; and performing feature extraction on the target-domain semantic label through the target-domain label feature extraction network to obtain the second semantic label vector;
concatenating the second content vector and the second semantic label vector through the target-domain concatenation layer to obtain a target-domain concatenated vector; and
performing feature extraction on the target-domain concatenated vector through the target-domain representation layer to obtain the target-domain content vector.

14. The method according to claim 13, wherein the source-domain node feature extraction network comprises a source-domain node input layer, a source-domain node embedding layer, and a source-domain node representation layer that are cascaded, and the source-domain label feature extraction network comprises a source-domain semantic label input layer, a source-domain embedded-representation encoder, and a source-domain label representation layer that are cascaded;
the performing feature extraction on the source-domain content through the source-domain node feature extraction network to obtain the first content vector comprises:
inputting a content feature of the source-domain content through the source-domain node input layer;
performing embedding representation on the content feature of the source-domain content through the source-domain node embedding layer to obtain an embedded representation vector of the source-domain content; and
learning the embedded representation vector of the source-domain content through the source-domain node representation layer to obtain the first content vector; and
the performing feature extraction on the source-domain semantic label through the source-domain label feature extraction network to obtain the first semantic label vector comprises:
inputting a semantic feature of the source-domain semantic label through the source-domain semantic label input layer;
performing embedding representation on the semantic feature of the source-domain semantic label through the source-domain embedded-representation encoder to obtain an embedded representation vector of the source-domain semantic label; and
learning the embedded representation vector of the source-domain semantic label through the source-domain label representation layer to obtain the first semantic label vector.

15. The method according to claim 13, wherein the target-domain node feature extraction network comprises a target-domain node input layer, a target-domain node embedding layer, and a target-domain node representation layer that are cascaded, and the target-domain label feature extraction network comprises a target-domain semantic label input layer, a target-domain embedded-representation encoder, and a target-domain label representation layer that are cascaded;
the performing feature extraction on the target-domain content through the target-domain node feature extraction network to obtain the second content vector comprises:
inputting a content feature of the target-domain content through the target-domain node input layer;
performing embedding representation on the content feature of the target-domain content through the target-domain node embedding layer to obtain an embedded representation vector of the target-domain content; and
learning the embedded representation vector of the target-domain content through the target-domain node representation layer to obtain the second content vector; and
the performing feature extraction on the target-domain semantic label through the target-domain label feature extraction network to obtain the second semantic label vector comprises:
inputting a semantic feature of the target-domain semantic label through the target-domain semantic label input layer;
performing embedding representation on the semantic feature of the target-domain semantic label through the target-domain embedded-representation encoder to obtain an embedded representation vector of the target-domain semantic label; and
learning the embedded representation vector of the target-domain semantic label through the target-domain label representation layer to obtain the second semantic label vector.

16. A non-transitory computer-readable storage medium, the readable storage medium having at least one program stored therein, and the at least one program being loaded and executed by a processor to implement:
constructing a heterogeneous network, the heterogeneous network comprising a node bipartite graph between sample source-domain content nodes and sample target-domain content nodes, a first label bipartite graph between the sample source-domain content nodes and sample source-domain semantic labels, and a second label bipartite graph between the sample target-domain content node and sample target-domain semantic labels;
generating a plurality of training samples based on the heterogeneous network, a training sample being generated based on a sample source-domain content node and a sample target-domain content node between which a connecting edge exists in the node bipartite graph, a sample source-domain semantic label corresponding to the sample source-domain content node in the first label bipartite graph, and a sample target-domain semantic label corresponding to the sample target-domain content node in the second label bipartite graph; and
training a cross-domain recommendation model based on the plurality of training samples.

17. The storage medium according to claim 16, wherein the cross-domain recommendation model comprises a source-domain semantic tower, a target-domain semantic tower, and a matching layer; and
the training a cross-domain recommendation model based on the training sample comprises:
for a training sample, inputting the sample source-domain content node and the sample source-domain semantic label corresponding to the sample source-domain content node into the source-domain semantic tower to obtain a sample source-domain content vector; and inputting the sample target-domain content node and the sample target-domain semantic label corresponding to the sample target-domain content node into the target-domain semantic tower to obtain a sample target-domain content vector;
inputting the sample source-domain content vector and the sample target-domain content vector into the matching layer to obtain a predicted similarity;
calculating an error loss between the predicted similarity and a real sample similarity; and
training the cross-domain recommendation model based on the error loss.

18. The storage medium according to claim 17, wherein the source-domain semantic tower comprises a source-domain node feature extraction network, a source-domain label feature extraction network, a source-domain concatenation layer, and a source-domain representation layer that are cascaded, and the target-domain semantic tower comprises a target-domain node feature extraction network, a target-domain label feature extraction network, a target-domain concatenation layer, and a target-domain representation layer that are cascaded;
the inputting the sample source-domain content node and the sample source-domain semantic label corresponding to the sample source-domain content node into the source-domain semantic tower to obtain a sample source-domain content vector comprises:
inputting the sample source-domain content node into the source-domain node feature extraction network to obtain a first sample content vector; and inputting the sample source-domain semantic label into the source-domain label feature extraction network to obtain a first sample semantic label vector;
inputting the first sample content vector and the first sample semantic label vector into the source-domain concatenation layer to obtain a sample source-domain concatenated vector; and
inputting the sample source-domain concatenated vector into the source-domain representation layer to obtain the sample source-domain content vector; and
the inputting the sample target-domain content node and the sample target-domain semantic label corresponding to the sample target-domain content node into the target-domain semantic tower to obtain a sample target-domain content vector comprises:
inputting the sample target-domain content node into the target-domain node feature extraction network to obtain a second sample content vector; and inputting the sample target-domain semantic label into the target-domain label feature extraction network to obtain a second sample semantic label vector;
inputting the second sample content vector and the second sample semantic label vector into the target-domain concatenation layer to obtain a sample target-domain concatenated vector; and
inputting the sample target-domain concatenated vector into the target-domain representation layer to obtain the sample target-domain content vector.

19. The storage medium according to claim 16, wherein the generating a training sample based on a sample source-domain content node and a sample target-domain content node between which a connecting edge exists in the node bipartite graph, a sample source-domain semantic label corresponding to the sample source-domain content node in the first label bipartite graph, and a sample target-domain semantic label corresponding to the sample target-domain content node in the second label bipartite graph comprises:
determining the sample source-domain content nodes and the corresponding sample source-domain semantic labels in the first label bipartite graph as sample source-domain data; and
determining the sample target-domain content nodes and the corresponding sample target-domain semantic labels in the second label bipartite graph as sample target-domain data;
determining a real sample similarity between the sample source-domain data and the sample target-domain data based on a weight on the connecting edge, wherein the weight is determined based on a quantity of co-occurrences between the sample source-domain content node and the sample target-domain content node in a period of time; and
determining the sample source-domain data, the sample target-domain data, and the real sample similarity as the training sample.

20. The storage medium according to claim 16, wherein the heterogeneous network further comprises: a source-domain co-occurrence network constructed based on sample source-domain content nodes in a co-occurrence relationship and a target-domain co-occurrence network constructed based on sample target-domain content nodes in a co-occurrence relationship; and
the node bipartite graph comprises a first sample source-domain content node and a first sample target-domain content node between which a connecting edge exists, and the method further comprises:
when a second sample source-domain content node in a co-occurrence relationship with the first sample source-domain content node exists in the source-domain co-occurrence network, generating a training sample by using the second sample source-domain content node, the first sample target-domain content node, a sample source-domain semantic label corresponding to the second sample source-domain content node in the first label bipartite graph, and a sample target-domain semantic label corresponding to the first sample target-domain content node in the second label bipartite graph;
when a second sample target-domain content node in a co-occurrence relationship with the first sample target-domain content node exists in the target-domain co-occurrence network, generating a training sample by using the first sample source-domain content node, the second sample target-domain content node, a sample source-domain semantic label corresponding to the first sample source-domain content node in the first label bipartite graph, and a sample target-domain semantic label corresponding to the second sample target-domain content node in the second label bipartite graph; or
when a second sample source-domain content node in a co-occurrence relationship with the first sample source-domain content node exists in the source-domain co-occurrence network, and a second sample target-domain content node in a co-occurrence relationship with the first sample target-domain content node exists in the target-domain co-occurrence network, generating a training sample by using the second sample source-domain content node, the second sample target-domain content node, a sample source-domain semantic label corresponding to the second sample source-domain content node in the first label bipartite graph, and a sample target-domain semantic label corresponding to the second sample target-domain content node in the second label bipartite graph.
